(19) United States
(12) Patent Application Publication
(10) Pub. No.: US 2018/0063761 A1
(43) Pub. Date: Mar. 1, 2018

(54) WIRELESS COMMUNICATIONS SYSTEM, WIRELESS COMMUNICATIONS APPARATUS, AND HANDOVER CONTROL METHOD

(71) Applicant: FUJITSU LIMITED, Kawasaki-shi (JP)

(72) Inventor: Hiroaki SENOO, Kawasaki (JP)

(73) Assignee: FUJITSU LIMITED, Kawasaki-shi (JP)

(21) Appl. No.: 15/796,460

(22) Filed: Oct. 27, 2017

Related U.S. Application Data
(63) Continuation of application No. PCT/JP2015/064114, filed on May 15, 2015.

(51) Int. Cl. H04W 36/18; H04W 36/06; H04W 88/04

(52) U.S. Cl. CPC H04W 36/18; H04W 36/14; H04W 88/04; H04W 36/06

(57) ABSTRACT

A wireless communications system includes a first relay apparatus connected to a first communications network; a second relay apparatus connected to a second communications network different from the first communications network; a second terminal configured to communicate with a first terminal via the second relay apparatus; and a wireless communications apparatus configured to perform handover of the second terminal, the wireless communications apparatus, when performing handover of the second terminal, disconnects communication via the second relay apparatus and performs the handover by a path change of the first relay apparatus when the communication via the second relay apparatus passes through the second communications network, the wireless communications apparatus performing the handover through a path change of the second relay apparatus without disconnecting the communication via the second relay apparatus when the communication via the second relay apparatus does not pass through the second communications network.

### CROSS REFERENCE TO RELATED APPLICATIONS

This application is a continuation application of International Application PCT/JP2015/064114, filed on May 15, 2015, and designating the U.S., the entire contents of which are incorporated herein by reference.

### FIELD

The embodiments discussed herein relate to a wireless communications system, a wireless communications apparatus, and a handover control method.

### BACKGROUND

Local IP Access (LIPA) is conventionally known that offloads user data to a local network to reduce the traffic load on a core network. A technique that relates to handover control via a base station in a configuration including a local gateway (L-GW) connected to a local network and the base station is known (see, e.g., Published Japanese-Translation of PCT Application, Publication No. 2013-526087 and Japanese Laid-Open Patent Publication No. 2013-17093).

A technique is also known that shortens an intra-network path in communication between terminals by a shortcut communication path through a base station or a gateway, such as enhancements for Infrastructure based data Communication Between Devices (eICBD) of LTE-A (see, e.g., 3GPP TR22.807 V13.0.0).

### SUMMARY

According to an aspect of the invention, a wireless communications system includes a first relay apparatus connected to a first communications network; a second relay apparatus different from the first relay apparatus and connected to a second communications network different from the first communications network; a second terminal configured to communicate with a first terminal via the second relay apparatus; and a wireless communications apparatus configured to perform handover of the second terminal, the wireless communications apparatus, when performing handover of the second terminal, disconnects communication via the second relay apparatus and performs the handover by a path change of the first relay apparatus when the communication via the second relay apparatus passes through the second communications network, the wireless communications apparatus performing the handover through a path change of the second relay apparatus without disconnecting the communication via the second relay apparatus when the communication via the second relay apparatus does not pass through the second communications network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of an example of a wireless communications system according to a first embodiment;

FIG. 2 is a diagram of an example of communication between terminals according to the first embodiment;

FIGS. 3 and 4 are diagrams of an example of a configuration of L-GWs and HO according to the first embodiment;

FIG. 5 is a diagram of an example of an L-GW according to the first embodiment;

FIG. 6 is a diagram of an example of protocol conversion in the L-GW according to the first embodiment;

FIG. 7 is a diagram of an example of a base station according to the first embodiment;

FIG. 8 is a sequence diagram of an example of a process in a case of transmitting an HO request and omitting a path change process in the first embodiment;

FIG. 9 is a sequence diagram of an example of a process in a case of transmitting an HO request without omitting the path change process on a NW side in the first embodiment;

FIG. 10 is a sequence diagram of an example of a process in a case when the HO request is not transmitted in the first embodiment;

FIG. 11 is a diagram of an example of the HO request according to the first embodiment;

FIG. 12 is a flowchart of an example of a communication type detection process according to the first embodiment;

FIG. 13 is a flowchart of an example of a communication type acquisition process by the HO-source L-GW according to the first embodiment;

FIG. 14 is a flowchart of an example of an HO-source omission determination process and a process based on the HO-source omission determination process according to the first embodiment;

FIG. 15 is a flowchart of an example of an HO-source path determination process and transmission of an HO-source path establishment request according to the first embodiment;

FIG. 16 is a flowchart of an example of an HO-source path change process according to the first embodiment;

FIG. 17 is a flowchart of an example of the HO-destination path determination process and a process based on the HO-destination path determination process according to the first embodiment;

FIG. 18 is a flowchart of an example of an HO-destination path change process according to the first embodiment;

FIG. 19 is a diagram of an example of a change in communication path due to HO when the HO request is transmitted and the path change process on the NW side is not omitted in the first embodiment;

FIG. 20 is a diagram of an example of a change in communication path due to HO when the HO request is not transmitted in the first embodiment;

FIG. 21 is a diagram of an example of a change in communication path due to HO when the HO request is transmitted and the path change process on the NW side is omitted in the first embodiment;

FIG. 22 is a reference diagram of an example when the path change process is omitted at the time of HO in non-shortcut communication;

FIGS. 23 and 24 are diagrams of examples of configuration of L-GWs and HO according to a second embodiment;

FIG. 25 is a diagram of an example of the base station according to the second embodiment;

FIG. 26 is a sequence diagram of an example of a process in a case of transmitting an HO request and omitting a path change process in the second embodiment;

FIG. 27 is a sequence diagram of an example of a process in a case of transmitting an HO request without omitting the path change process on the NW side in the second embodiment;

FIG. 28 is a sequence diagram of an example of a process in a case when the HO request is not transmitted in the second embodiment;

FIG. 29 is a flowchart of an example of the communication type detection process according to the second embodiment;

FIG. 30 is a flowchart of an example of the communication type acquisition process by the HO-source base station according to the second embodiment;

FIG. 31 is a flowchart of an example of the HO-source path determination process and the HO-source path change process according to the second embodiment;

FIG. 32 is a flowchart of an example of the HO-destination path determination process and the HO-destination path change process according to the second embodiment;

FIGS. 33 and 34 are diagrams of examples of configuration of L-GWs and HO according to a third embodiment;

FIG. 35 is a diagram of an example of the L-GW according to the third embodiment;

FIG. 36 is a sequence diagram of an example of a process in a case of transmitting an HO request and omitting a path change process in the third embodiment;

FIG. 37 is a sequence diagram of an example of a process in a case of transmitting an HO request without omitting the path change process on the NW side in the third embodiment;

FIG. 38 is a sequence diagram of an example of a process in a case when the HO request is not transmitted in the third embodiment; and

FIG. 39 is a flowchart of an example of the HO-destination path determination process and a process based on the HO destination path determination process according to the third embodiment.

### DESCRIPTION OF THE INVENTION

With conventional techniques a problem arises in that when handover of a terminal occurs while communication between terminals such as voice communication is performed through a shortcut path shortened at an L-GW, path switching at a P-GW or an S-GW is performed after the communication between the terminals via the L-GW is disconnected. Therefore, it takes time to complete the handover, which causes a problem of a longer instantaneous interruption time for the communication between terminals due to the handover.

Embodiments of a wireless communications system, a wireless communications apparatus, and a handover control method according to the present invention will be described in detail with reference to the accompanying drawings.

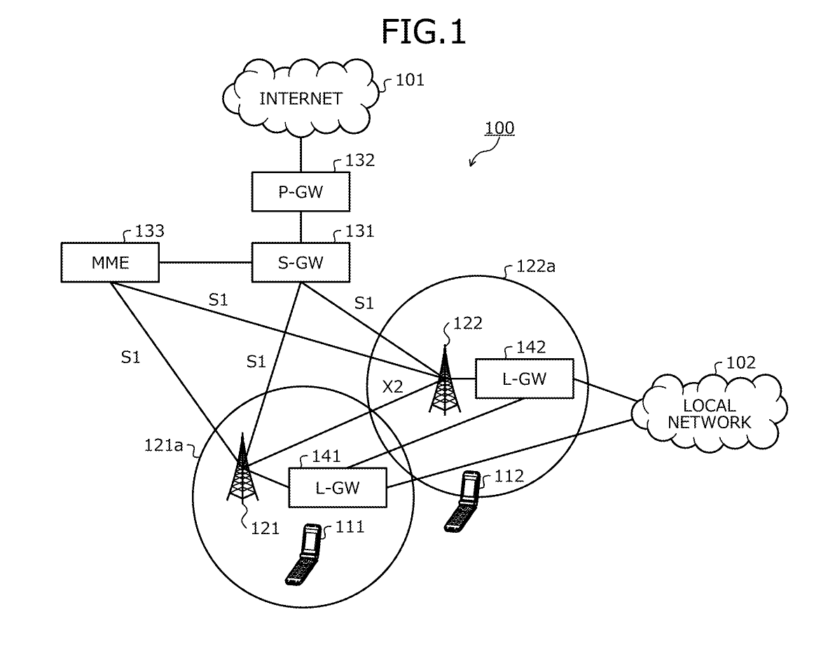

FIG. 1 is a diagram of an example of a wireless communications system according to a first embodiment. As depicted in FIG. 1, a wireless communications system 100 according to the first embodiment includes terminals 111, 112, base stations 121, 122, an S-GW 131, a P-GW 132, an MME 133, and L-GWs 141, 142. An internet 101 is a wide area network connected to the P-GW 132. A local network 102 is a local network provided near the base stations 121, 122. The local network 102 may be connected to the internet 101.

The terminals 111, 112 are User Equipment (UE) performing wireless communication with the base stations 121, 122. In the example depicted in FIG. 1, the terminal 111 is present in a cell 121a of the base station 121 and performs wireless communication with the base station 121. The terminal 112 is present in a cell 122a of the base station 122 and performs wireless communication with the base station 122. The terminals 111, 112 can perform communication with each other.

The base stations 121, 122 are wireless communications apparatuses forming the cells 121a, 122a, respectively, and are configured to perform wireless communication with terminals present in the cells thereof. For example, the base stations 121, 122 are evolved Nodes B (eNBs). In the example depicted in FIG. 1, the base station 121 performs wireless communication with the terminal 111 present in the cell 121a. The base station 122 performs wireless communication with the terminal 112 present in the cell 122a. The base stations 121, 122 are connected to the S-GW 131 and the MME 133 through an S1 interface. The base stations 121, 122 are connected with each other through an X2 interface.

The S-GW 131 and the P-GW 132 are first relay apparatuses connected to the internet 101 (first communications network). The serving gateway (S-GW) 131 is a serving gateway accommodating the base stations 121, 122 and configured to execute User Plane (U-plane) processing in communication via the base stations 121, 122. For example, the S-GW 131 executes U-plane processing in communication of the terminal 111 via the base station 121.

The packet data network gateway (P-GW) 132 is a packet data network gateway for connecting to an external network such as the internet 101. For example, the P-GW 132 relays user data between the S-GW 131 and the internet 101. For example, the P-GW 132 has functions of performing packet filtering, Internet Protocol (IP) address assignment, etc. for each terminal.

The mobility management entity (MME) 133 accommodates the base stations 121, 122 and is configured to execute Control Plane (C-plane) processing in communication via the base stations 121, 122. For example, the MME 133 executes C-plane processing in the communication of the terminal 111 through the base station 121. C-plane is a function group for controlling a call and a network between apparatuses. For instance, C-plane is used for connection of a packet call, configuration of a path for transmitting user data, control of handover, etc.

The L-GWs 141, 142 are second relay apparatuses connected to the local network 102 (second communications network). The L-GW 141 is a local gateway between the base station 121 and the local network 102. The L-GW 142 is the local gateway between the base station 122 and the local network 102. The L-GWs 141, 142 are connected with each other by an inter-gateway interface.

The L-GWs 141, 142 have functions of performing direct tunneling with a radio access network (RAN), IP address assignment, etc.

In the example depicted in FIG. 1, the L-GWs 141, 142 are provided physically independent of the base stations 121, 122, respectively; however, the present invention is not limited to such a configuration. For example, the base stations 121, 122 may be provided with the functions of the L-GWs 141, 142, respectively. In the description of this embodiment, the L-GWs 141, 142 are provided physically independent of the base stations 121, 122, respectively.

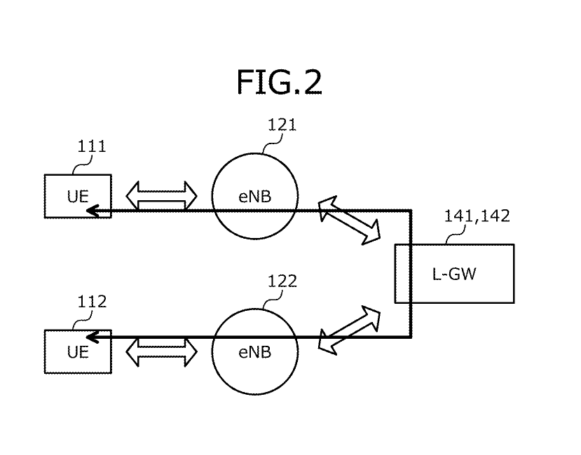

FIG. 2 is a diagram of an example of communication between terminals according to the first embodiment. In FIG. 2, parts similar to those depicted in FIG. 1 are denoted by the same reference numerals used in FIG. 1 and will not be described. In the wireless communications system 100 according to the first embodiment, a communication path in a case in which communication is performed between terminals such as voice communication between the terminal 111 and the terminal 112 will be described.

The terminals 111, 112 can perform communication between terminals via the L-GWs 141, 142 without passing through the S-GW 131 and the P-GW 132, for example. As a result, traffic on a core network including the S-GW 131 and the P-GW 132 can be reduced.

For such communication via the L-GW, e.g., LIPA Packet Data Network (PDN) connection, can be used. The LIPA PDN connection is specified in TS 23.401 and TR 23.829 of 3GPP, for example.

As depicted in FIG. 2, the terminals 111, 112 can perform communication between terminals though a data path (shortened path) without passing through the local network 102 by a shortcut at the L-GWs 141, 142. Such a data path is specified in TR 22.807 of 3GPP, for example. As a result, traffic on the local network 102 and delays in communication between terminals can be reduced.

In the example depicted in FIG. 2, data from the terminal 111 to the terminal 112 passes through the base station 121, the L-GWs 141, 142, and the base station 122 in this order and is transmitted to the terminal 112 without passing through the local network 102. Data from the terminal 112 to the terminal 111 passes through the base station 122, the L-GWs 141, 142, and the base station 121 in this order and is transmitted to the terminal 111 without passing through the local network 102.

A case will be described in which handover (HO) of at least one of the terminals 111, 112 occurs when the shortcut communication via the L-GWs depicted in FIG. 2 is performed between the terminals 111, 112. In such a case, according to a conventional process, the communication connection (LIPA PDN connection) via the L-GWs is released before performing HO, and the HO of the communication via the P-GW 132 is performed. Therefore, it takes time to complete HO and the instantaneous interruption time of communication between terminals due to handover increases.

In contrast, in the present embodiment, when a terminal that is to be handed over is communicating with another terminal by shortcut communication via the L-GWs, HO can be performed without disconnecting the communication via the L-GWs. Since HO is performed without disconnecting the communication via the L-GWs, no path changing process on the side of the P-GW 132 is executed whereby the instantaneous interruption time at HO can be reduced.

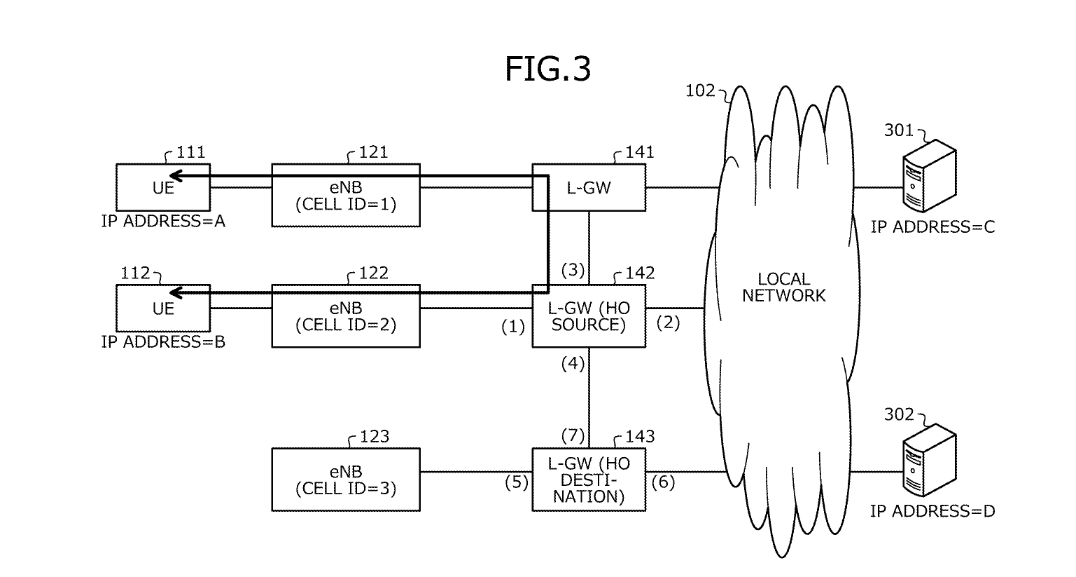

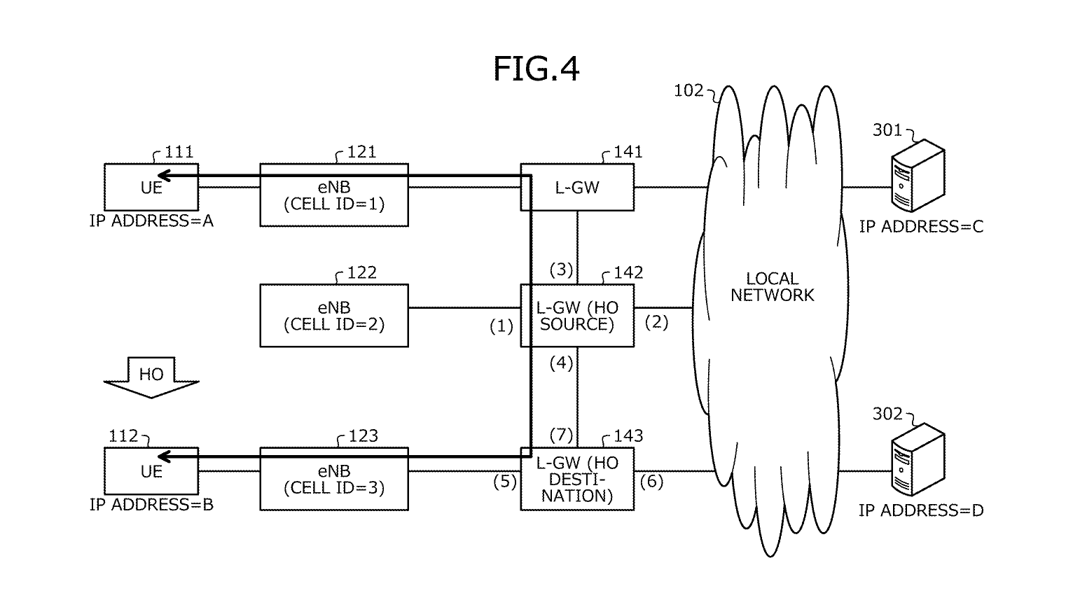

FIGS. 3 and 4 are diagrams of an example of a configuration of L-GWs and HO according to the first embodiment. In FIGS. 3 and 4, parts similar to those depicted in FIG. 1 are denoted by the same reference numerals used in FIGS. 3 and 4, and will not be described. A base station 123 depicted in FIGS. 3 and 4 is an eNB different from the base stations 121, 122. Similar to the base stations 121, 122, the base station 123 is connected to the S-GW 131 and the MME 133. An L-GW 143 depicted in FIGS. 3 and 4 is a local gateway between the base station 123 and the local network 102.

As depicted in FIGS. 3 and 4, the first embodiment will be described in terms of a case where the L-GWs 141 to 143 are connected to the base stations 121 to 123, respectively. The terminals 111, 112 are assumed to have IP addresses A, B, respectively. Servers 301, 302 are connected to the local network 102, and the servers 301, 302 are assumed to have IP addresses C, D, respectively.

First, as depicted in FIG. 3, it is assumed that the terminals 111, 112 are respectively connected to the base stations 121, 122 and that communication is performed between the terminals 111, 112 through a data path passing through the base station 121, the L-GWs 141, 142, and the base station 122. Subsequently, as depicted in FIG. 4, it is assumed that HO of the terminal 112 has occurred from the base station 122 to the base station 123 due to movement, etc. of the terminal 112. As a result, communication is performed between the terminals 111, 112 through a data path passing through the base station 121, the L-GWs 141 to 143, and the base station 123.

In FIGS. 3 and 4, (1) to (4) denote numbers of output ports (communication ports) in the L-GW 142 corresponding to the handover-source (HO-source) base station 122. For example, (1) denotes the number of the output port (UE direction) connected to the base station 122, in the L-GW 142; (2) denotes the number of the output port (network (NW) direction) connected to the local network 102, in the L-GW 142; (3) denotes the number of the output port (L-GW direction) connected to the L-GW 141, in the L-GW 142; and (4) denotes the number of the output port (L-GW direction) connected to the L-GW 143, in the L-GW 142.

In FIGS. 3 and 4, (5) to (7) denote numbers of output ports in the L-GW 143 corresponding to the handover-destination (HO-destination) base station 123. For example, (5) denotes the number of the output port (UE direction) connected to the base station 123, in the L-GW 143; (6) denotes the number of the output port (NW direction) connected to the local network 102, in the L-GW 143; and (7) denotes the number of the output port (L-GW direction) connected to the L-GW 142, in the L-GW 143.

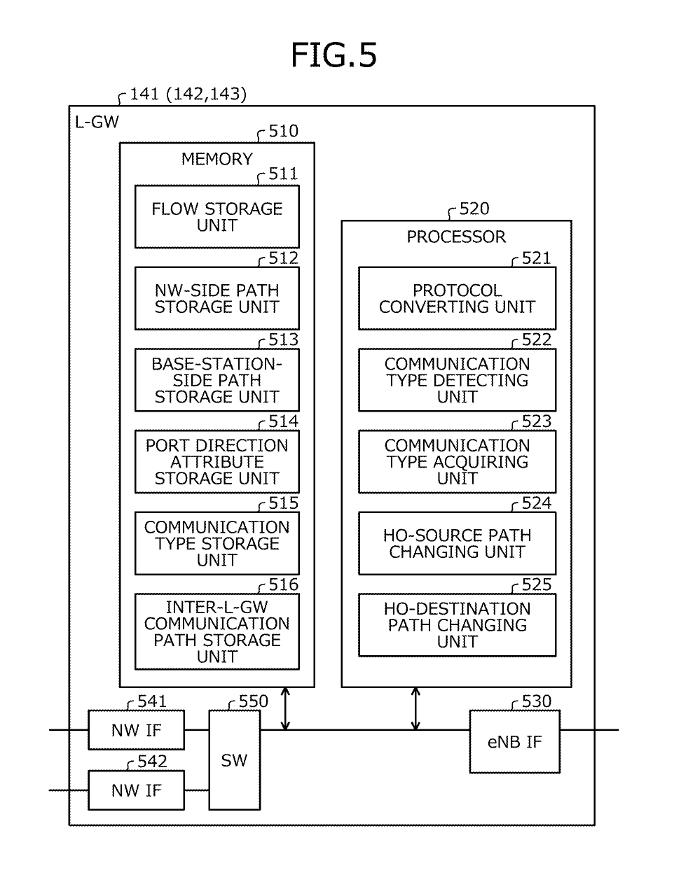

FIG. 5 is a diagram of an example of the L-GW according to the first embodiment. Although the configuration of the L-GW 141 will be described in FIG. 5, the configurations of the L-GWs 142, 143 are similar to the configuration of the L-GW 141. As depicted in FIG. 5, the L-GW 141 includes a memory 510, a processor 520, a base station interface 530, network interfaces 541, 542, and a switch 550.

The memory 510 includes a main memory and an auxiliary memory, for example. The main memory is a random access memory (RAM), for example. The main memory is used as a work area of the processor 520. The auxiliary memory is a nonvolatile memory such as a magnetic disk, an optical disk, and a flash memory, for example. Various programs for operating the L-GW 141 are stored in the auxiliary memory. The programs stored in the auxiliary memory are loaded to the main memory and executed by the processor 520.

The L-GW 141 also includes a flow storage unit 511, an NW-side path storage unit 512, a base-station-side path storage unit 513, a port direction attribute storage unit 514, a communication type storage unit 515, and an inter-L-GW communication path storage unit 516, respectively implemented by the memory 510.

The flow storage unit 511 stores information for protocol conversion. The information for protocol conversion includes combination information of an external IP address, Tunnel Endpoint Identifier (TEID), a User Datagram Protocol (UDP) port number, and an internal IP address, for example.

The NW-side path storage unit 512 stores routing information related to the external IP address. The routing information related to the external IP address includes information indicating relationships between the external IP address and the port number of the network interface (NW IF), for example. Information stored in the NW-side path storage unit 512 will be described later (see, e.g., Table 8).

The base-station-side path storage unit 513 stores routing information related to the internal IP address. The routing information related to the internal IP address includes the internal IP address and the port number of the base station interface 530, for example.

The port direction attribute storage unit 514 stores a relationship between the output port number and the apparatus connected in the direction of the output port (the eNB direction, the UE direction, the L-GW direction, the NW direction). For example, information indicating relationships between the output port number and the direction attribute of the output port is included. Information stored in the port direction attribute storage unit 514 will be described later (see, e.g., Table 7).

The communication type storage unit 515 stores a communication type of each terminal detected by a communication type detecting unit 522 in the processor 520. Information stored in the communication type storage unit 515 will be described later (see, e.g., Table 9).

The inter-L-GW communication path storage unit 516 stores information indicating relationships between a cell ID of an adjacent base station and an output port number of an adjacent L-GW. Information stored in the inter-L-GW communication path storage unit 516 will be described later (see, e.g., Table 1).

The L-GW 141 implements a protocol converting unit 521, the communication type detecting unit 522, a communication type acquiring unit 523, an HO-source path changing unit 524, and an HO-destination path changing unit 525 by the processor 520.

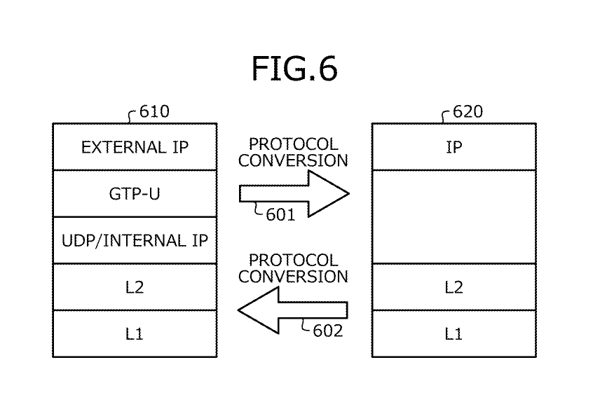

The protocol converting unit 521 refers to the flow storage unit 511 of the memory 510 to perform protocol conversion of data relayed by the L-GW 141. The protocol conversion by the protocol converting unit 521 will be described later (see, e.g., FIG. 6).

The communication type detecting unit 522 executes a communication type detection process of acquiring a communication type of communication of a terminal. For example, the communication type detecting unit 522 acquires a destination IP address and a source IP address from data after the protocol conversion by the protocol converting unit 521 (data after conversion through protocol conversion 601 depicted in FIG. 6 described later). Alternatively, the communication type detecting unit 522 may acquire a destination IP address and a source IP address of data transmitted from the local network 102. The communication type detecting unit 522 refers to the NW-side path storage unit 512 to acquire the output port numbers corresponding to the acquired destination and source IP addresses. The communication type detecting unit 522 refers to the port direction attribute storage unit 514 to acquire the direction attribute of the port corresponding to the acquired output port number.

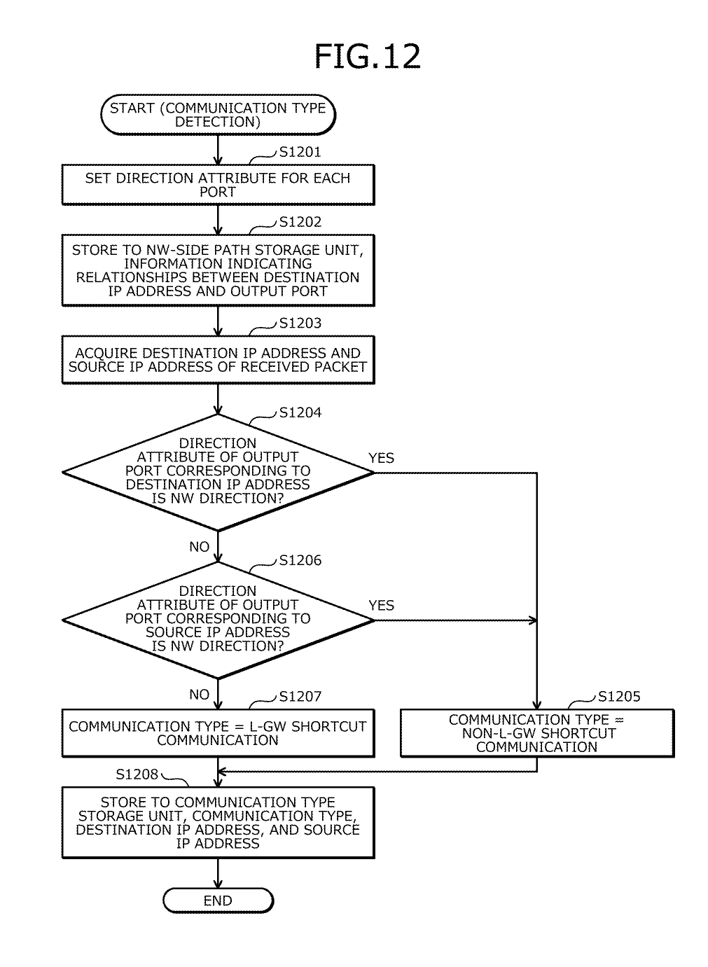

When the direction attributes of the output ports corresponding to the destination IP address and the source IP address are both the UE direction or the L-GW direction, the communication type detecting unit 522 determines that the communication type is L-GW shortcut communication. When at least one of the direction attributes of the output ports corresponding to the destination IP address and the source IP address is neither the UE direction nor the L-GW direction, the communication type detecting unit 522 determines that that the communication type is non-L-GW shortcut communication. The communication type detection process by the communication type detecting unit 522 will be described later (see, e.g., FIG. 12). The communication type detecting unit 522 stores the detected communication type to the communication type storage unit 515.

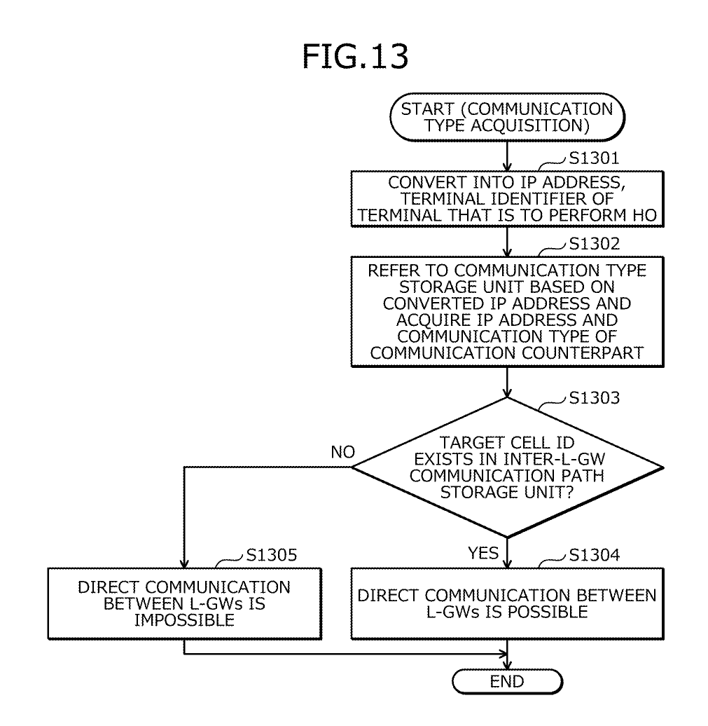

The communication type acquiring unit 523 executes a communication type acquisition process of acquiring a communication type of communication of a terminal. For example, when receiving a communication type inquiry from a base station (e.g., the base station 121), the communication type acquiring unit 523 generates and transmits a communication type inquiry response. The communication type acquisition process by the communication type acquiring unit 523 will be described later (see, e.g., FIG. 13).

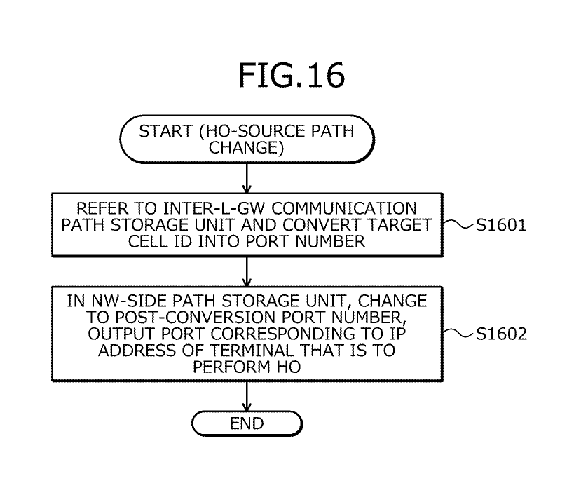

When receiving an HO-source path change request from a base station (e.g., the base station 121), the HO-source path changing unit 524 executes an HO-source path change process of changing a communication path in the L-GW of the HO source for the terminal that is to perform HO. The HO-source path change process by the HO-source path changing unit 524 will be described later (see, e.g., FIG. 16).

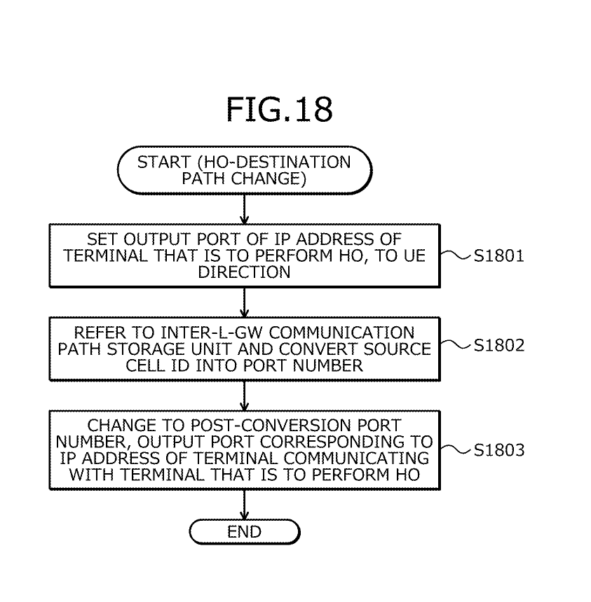

When receiving an HO-destination path change request from the base station 123, the HO-destination path changing unit 525 executes an HO-destination path change process of changing the communication path at the L-GW of the HO destination for the terminal that is to perform HO. The HO-destination path change process by the HO-destination path changing unit 525 will be described later (see, e.g., FIG. 18).

The base station interface 530 (eNB IF) is a communication interface for a base station (e.g., the base station 121) that is the connection destination of the L-GW. The processor 520 uses the base station interface 530 to communicate with a base station that is the connection destination of the L-GW.

The network interfaces 541, 542 are communication interfaces for the local network 102 and another L-GW (e.g., the L-GW 142), respectively. The processor 520 uses the network interfaces 541, 542 and the switch 550 to communicate with the local network 102 and the other L-GWs.

The number of network interfaces is set to a number corresponding to the number of the connection-destination local networks 102 and other L-GWs. For example, since the L-GW 142 is connected to the L-GWs 141, 143 and the local network 102, the number of network interfaces can be set to three.

FIG. 6 is a diagram of an example of the protocol conversion in the L-GW according to the first embodiment. The protocol converting unit 521 depicted in FIG. 5 performs the protocol conversion depicted in FIG. 6, for example. In FIG. 6, a layer group 610 is a layer group corresponding to communication on the side of the base station 121 in the L-GW 141. Meanwhile, a layer group 620 is a layer group corresponding to communication on the side of the local network 102 in the L-GW 141.

An external IP of the layer group 610 is an IP used for routing in the local network 102. General Packet Radio Service Tunneling Protocol for User Plane (GTP-U) is General Packet Radio Service Tunneling Protocol (GTP) for the user plane.

A UDP is a user data protocol. An internal IP is an IP used for routing among the base stations 121 to 123, the S-GW 131, the P-GW 132, and the MME 133. L2 is Layer 2 (data link layer). L1 is Layer 1 (physical layer).

When data is transmitted from the base station 121 to the local network 102, the protocol converting unit 521 performs the protocol conversion 601 for the data from the base station interface 530 to the network interface 541. When data is transmitted from the local network 102 to the base station 121, the protocol converting unit 521 performs protocol conversion 602 for the data from the network interface 541 to the base station interface 530.

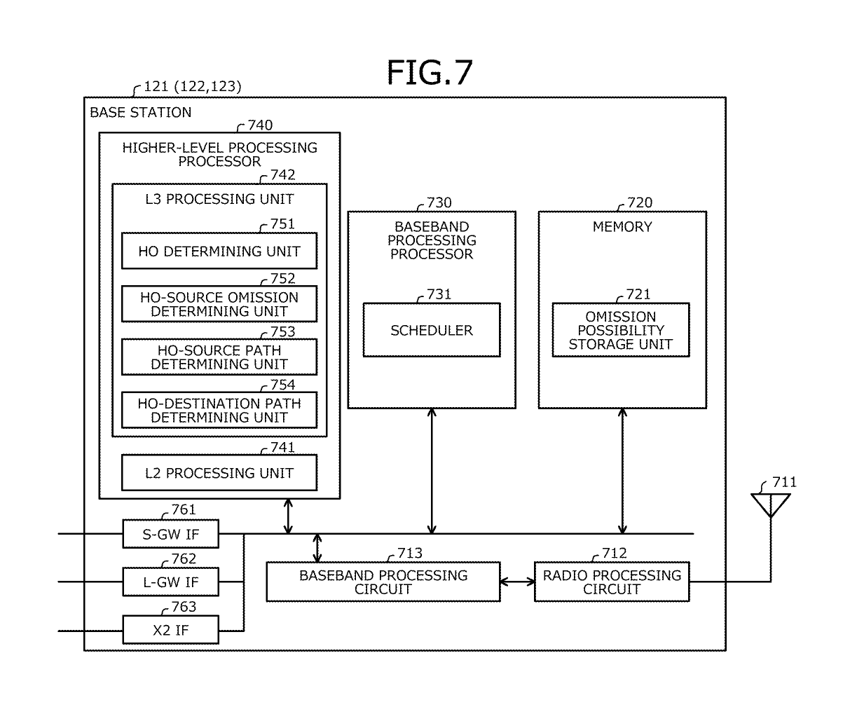

FIG. 7 is a diagram of an example of a base station according to the first embodiment. Although the configuration of the base station 121 will be described in FIG. 7, the configurations of the base stations 122, 123 are similar to the configuration of the base station 121. As depicted in FIG. 7, the base station 121 according to the first embodiment includes an antenna 711, a radio processing circuit 712, a baseband processing circuit 713, a memory 720, a baseband processing processor 730, and a higher-level processing processor 740. The base station 121 also includes an S-GW interface 761, an L-GW interface 762, and an X2 interface 763.

The baseband processing processor 730 and the higher-level processing processor 740 use the antenna 711, the radio processing circuit 712, and the baseband processing circuit 713 to perform wireless communication with a terminal present in the cell 121a of the base station 121.

The radio processing circuit 712 performs interconversion between a baseband frequency and a radio frequency. For example, the radio processing circuit 712 converts a signal output from the baseband processing circuit 713 from a baseband frequency to a radio frequency, before output to the antenna 711. The radio processing circuit 712 converts a signal output from the antenna 711 from a radio frequency to a baseband frequency, before output to the baseband processing circuit 713.

The radio processing circuit 712 may convert a signal output from the baseband processing circuit 713 from a digital signal to an analog signal, before output to the antenna 711. The radio processing circuit 712 may convert a signal output from the antenna 711 from an analog signal to a digital signal, before output to the baseband processing circuit 713. The radio processing circuit 712 may perform amplification, etc. of a signal.

The antenna 711 transmits/receives radio signals to/from a terminal (e.g., the terminal 111). For example, the antenna 711 wirelessly transmits a signal output from the radio processing circuit 712. The antenna 711 outputs a wirelessly received signal to the radio processing circuit 712.

The baseband processing circuit 713 mainly executes processes of the physical layer for signals wirelessly transmitted/received by the base station 121. The processes by the baseband processing circuit 713 include coding and modulation of a transmission signal, for example. The processes by the baseband processing circuit 713 include demodulation and decoding of a received signal, for example.

The memory 720 includes a main memory and an auxiliary memory, for example. The main memory is a RAM, for example. The main memory is used as a work area of the baseband processing processor 730 and the higher-level processing processor 740. The auxiliary memory is a nonvolatile memory such as a magnetic disk, an optical disk, and a flash memory, for example. Various programs for operating the base station 121 are stored in the auxiliary memory. The programs stored in the auxiliary memory are loaded to the main memory and executed by the baseband processing processor 730 and the higher-level processing processor 740.

The base station 121 includes an omission possibility storage unit 721. The omission possibility storage unit 721 is implemented by the memory 720. The omission possibility storage unit 721 stores omission possibility information that indicates whether a path change process on the NW side can be omitted.

The baseband processing processor 730 controls baseband processing in the baseband processing circuit 713. The baseband processing processor 730 includes a scheduler 731. The scheduler 731 is implemented by the baseband processing processor 730. The scheduler 731 controls assignment of radio resources to multiple terminals, etc.

The higher-level processing processor 740 executes processing of higher-level layers (e.g., L2 and L3 layer) in the communication of the base station 121. The base station 121 includes an L2 processing unit 741 and an L3 processing unit 742. The L2 processing unit 741 and the L3 processing unit 742 are implemented by the higher-level processing processor 740. A control unit that controls handover according to whether communication via the L-GW passes through the local network 102 can be implemented by the higher-level processing processor 740, for example.

The L2 processing unit 741 executes L2 processing in the communication of the base station 121. The L2 processing includes Medium Access Control (MAC) processing, Radio Link Control (RLC) processing, Packet Data Convergence Protocol (PDCP) processing, GTP-U processing, UDP processing, internal IP layer processing, etc.

The L3 processing unit 742 executes processing for a higher level than L2, such as the RRC layer, in the communication of the base station 121 and a termination of an inter-base station IF. For example, the processes include control and management of radio resources, transmission/reception of signals between base stations, and transmission/reception of signals to/from NW-side apparatuses. The NW-side apparatuses include the S-GW 131, the P-GW 132, and the L-GW 141, for example.

The L3 processing unit 742 includes an HO determining unit 751, an HO-source omission determining unit 752, an HO-source path determining unit 753, and an HO-destination path determining unit 754. The HO determining unit 751 receives measurement information transmitted from a terminal (e.g., the terminal 111) and provides acceptance control at the time of reception of an HO request, etc.

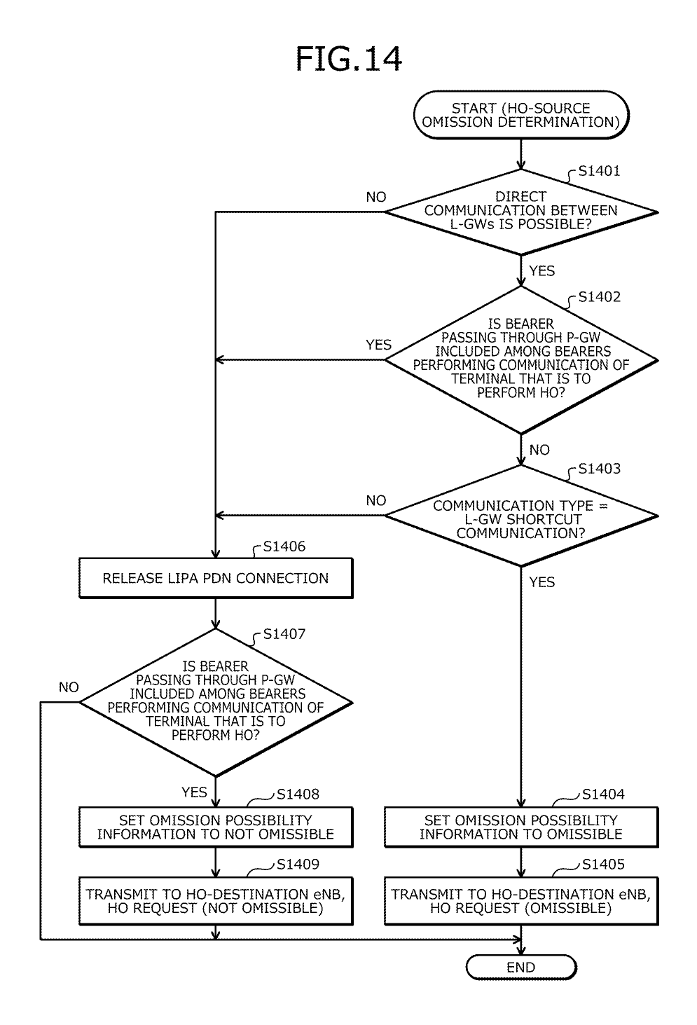

When the HO determining unit 751 determines that HO is to be performed, the HO-source omission determining unit 752 makes an inquiry about the communication type to the L-GW (e.g., the L-GW 142) that corresponds to the HO source. When receiving the communication type inquiry response, the HO-source omission determining unit 752 executes an HO-source omission determination process of determining whether to omit the path change process on the NW side. The HO-source omission determination process by the HO-source omission determining unit 752 will be described later (see, e.g., FIG. 14).

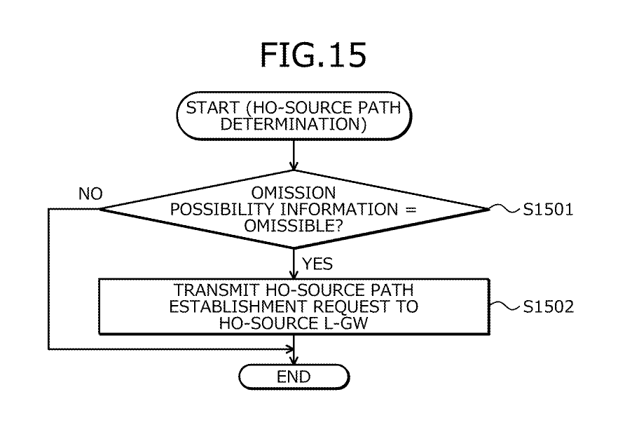

The HO-source path determining unit 753 executes an HO-source path determination process of determining whether to make a request for path change to the L-GW (e.g., the L-GW 142) corresponding to the HO-source. The HO-source path determination process by the HO-source path determining unit 753 will be described later (see, e.g., FIG. 15).

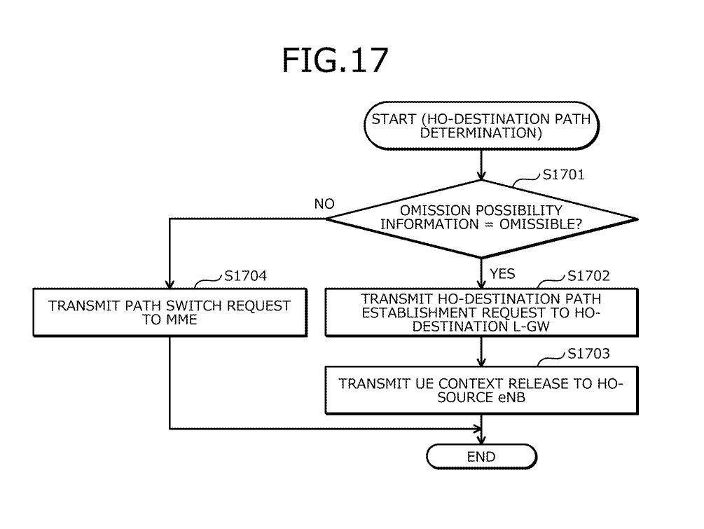

The HO-destination path determining unit 754 executes an HO-destination path determination process of determining whether to make a request for path change to the L-GW (e.g., the L-GW 143) corresponding to the HO-destination. The HO-destination path determination process by the HO-destination path determining unit 754 will be described later (see, e.g., FIG. 17).

The S-GW interface 761 (S-GW IF) is a communication interface for the S-GW 131. For example, the S-GW interface 761 is an S1 interface. The baseband processing processor 730 and the higher-level processing processor 740 use the S-GW interface 761 to communicate with the S-GW 131.

The L-GW interface 762 (L-GW IF) is a communication interface for an L-GW (e.g., the L-GW 141) connected to the base station 121. The baseband processing processor 730 and the higher-level processing processor 740 use the L-GW interface 762 to communicate with the L-GW (e.g., the L-GW 141) connected to the base station 121. An acquiring unit that acquires information that indicates whether communication via the L-GW passes through the local network 102 can be implemented by the L-GW interface 762.

The X2 interface 763 (X2 IF) is a communication interface for other base stations (e.g., the base stations 122, 123). The baseband processing processor 730 and the higher-level processing processor 740 use the X2 interface 763 to communicate with other base stations (e.g., the base stations 122, 123).

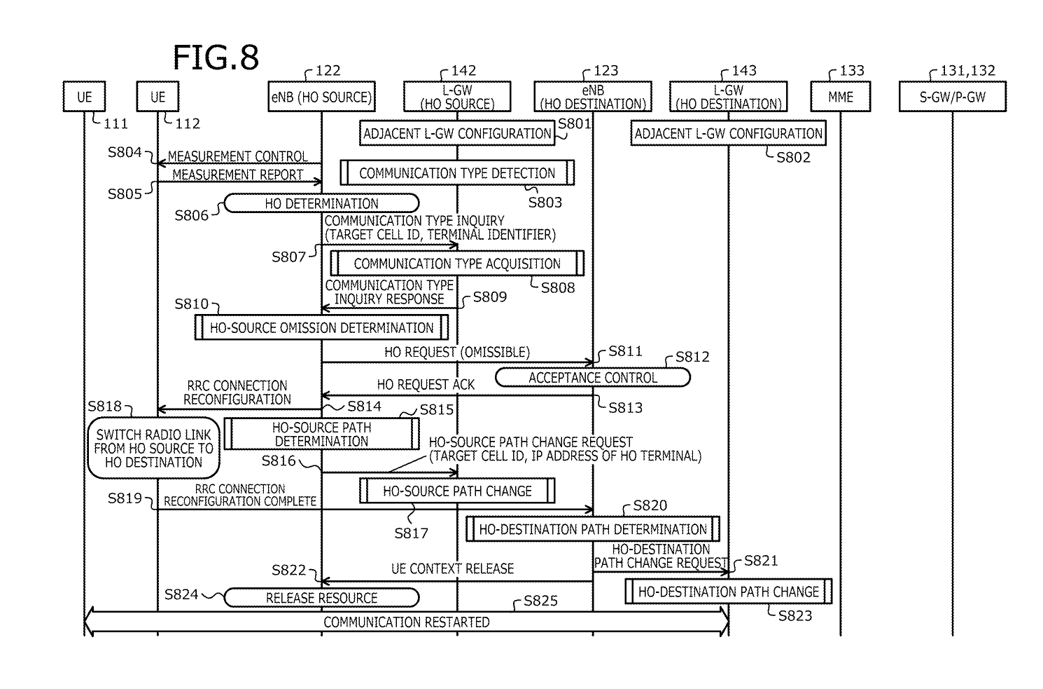

FIG. 8 is a sequence diagram of an example of a process in a case of transmitting an HO request and omitting a path change process in the first embodiment. In the wireless communications system 100 according to the first embodiment, for example, steps depicted in FIG. 8 are executed. In the example depicted in FIG. 8, description is given for a case where the HO request is transmitted and the path change process is omitted, when the HO of the terminal 112 is performed from the base station 122 to the base station 123.

First, for the L-GW 142 corresponding to the HO-source base station 122, adjacent L-GW configuration is performed to set information indicating relationships between the cell ID of the adjacent base station 122 and the output port number in the L-GW 142 (step S801). For the L-GW 143 corresponding to the HO-destination base station 123, adjacent L-GW configuration is performed to set information indicating relationships between the cell ID of the adjacent base station 123 and the output port number in the L-GW 143 (step S802). The configuration at steps S801, S802 is performed, for example, when the respective L-GWs 142, 143 are deployed. Examples of configuration will be described later (see, e.g., Tables 1 and 2).

The L-GW 142 then executes a communication type detection process of detecting the communication type of the terminal (e.g., the terminal 112) (step S803). The communication type includes the L-GW shortcut communication through a path shortcut at the L-GW without passing through the local network 102 and the non-L-GW shortcut communication through a path passing through the L-GW and the local network 102. The communication type detection process will be described later (see, e.g., FIG. 12).

The base station 122 provides measurement control to set a transmission condition of a measurement report of radio quality to the terminal 112 (step S804). When the measured radio quality satisfies the transmission condition set at step S804, the terminal 112 transmits a measurement report of the measured radio quality to the base station 122 (step S805). The measurement report of radio quality includes radio quality information of wireless communication such as Reference Signal Received Power (RSRP) and Reference Signal Received Quality (RSRQ). The measurement control and the measurement report at steps S804, S805 may be performed periodically between the base station 122 and the terminal 112.

The base station 122 receiving the measurement report determines whether to perform HO of the terminal 112, based on the radio quality information included in the received measurement report (step S806). For example, when the radio quality of the base station 123 measured at the terminal 112 is higher than the radio quality of the base station 122 measured at the terminal 112, the base station 122 determines to perform the HO of the terminal 112 to the base station 123. In the example depicted in FIG. 8, it is assumed that the base station 122 determines to perform the HO of the terminal 112 to the base station 123.

To the L-GW 142 corresponding to the HO-source base station 122, the base station 122 then transmits a communication type inquiry about the communication type for the terminal 112 that is to perform HO (step S807). The communication type inquiry includes, e.g., a target cell ID identifying the cell of the HO-destination base station 123 and information (e.g., a terminal identifier) capable of identifying the IP address of the terminal 112 that is to perform HO. The communication type inquiry will be described later (see, e.g., Table 3).

In response to the communication type inquiry at step S807, the L-GW 142 executes a communication type acquisition process of acquiring the communication type at the terminal 112 (step S808). The communication type acquired at step S808 includes, e.g., a communication type indicating whether the L-GW shortcut communication is possible and a communication type indicating whether direct communication between L-GWs is possible for the communication at the terminal 112. The communication type acquisition process will be described later (see, e.g., FIG. 13).

The L-GW 142 then transmits to the base station 122, the communication type inquiry response indicating the communication type acquired at step S808 (step S809). The communication type inquiry response will be described later (see, e.g., Table 4).

The base station 122 then executes an HO-source omission determination process to determine whether to transmit the HO request to the base station 123 and whether to omit the path change process on the NW side in a case where the HO request is transmitted to the base station 123 (step S810). The HO-source omission determination process will be described later (see, e.g., FIG. 14). In the example depicted in FIG. 8, description is given for a case where it is determined that the HO request is to be transmitted to the base station 123 and that the path change process on the NW side is to be omitted.

To the HO-destination base station 123, the base station 122 then transmits the HO request for requesting the HO of the terminal 112 (step S811). The HO request transmitted at step S811 includes, e.g., omission possibility information for the path change process on the NW side, information required for establishing a path between the base station 123 and the L-GW 143, information required for establishing a path between the L-GW 142 and the L-GW 143, etc.

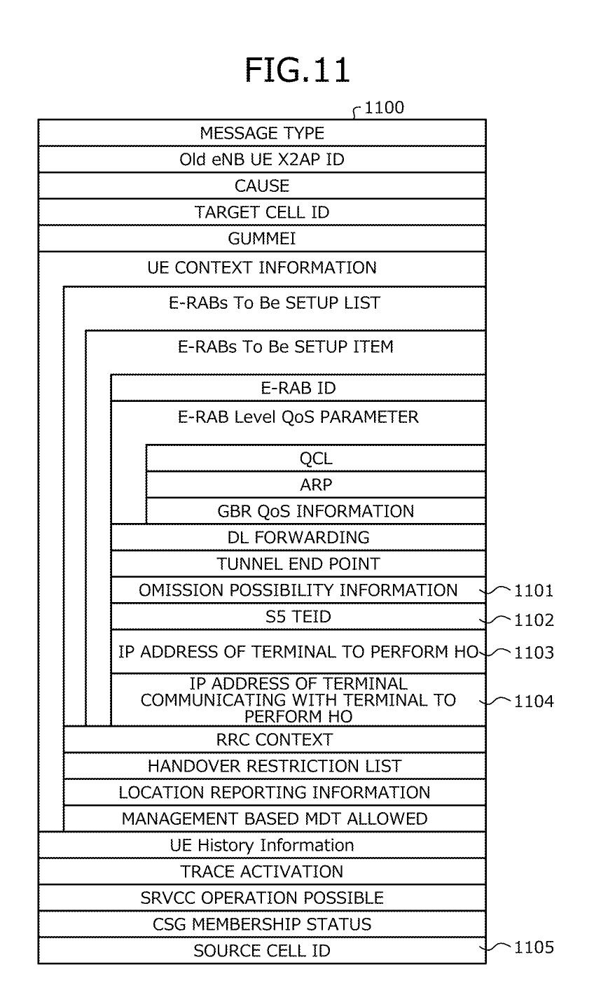

The omission possibility information for the path change process on the NW side is information that indicates the determination result at step S810 and is information that indicates that omission is possible, in the example depicted in FIG. 8. The information required for establishing a path between the base station 123 and the L-GW 143 includes S5 TEID, for example. The information required for establishing a path between the L-GW 142 and the L-GW 143 includes, e.g., the cell ID of the HO-source base station 122, the IP address of the terminal 112 that is to perform HO, and the IP address of the terminal 111 communicating with the terminal 112. The HO request will be described later (see, e.g., FIG. 11).

The base station 123 provides acceptance control of determining whether the HO of the terminal 112 to the base station 123 is acceptable (step S812). In the example depicted in FIG. 8, the base station 123 determines that the HO of the terminal 112 to the base station 123 is acceptable. The base station 123 then transmits to the base station 122, an HO request ACK indicating that the HO of the terminal 112 is acceptable (step S813).

The base station 122 then transmits to the terminal 112, Radio Resource Control Connection Reconfiguration (RRC Connection Reconfiguration) instructing the radio link to be changed from the base station 122 to the base station 123 (step S814). Based on the determination result at step S810, the base station 122 executes the HO-source path determination process of determining whether to make a request for path change to the L-GW 142 corresponding to the HO-source (step S815). The HO-source path determination process will be described later (see, e.g., FIG. 15). In the example depicted in FIG. 8, description is given for a case where it is determined at step S815 that a request for path change is to be made to the L-GW 142.

The base station 122 then transmits an HO-source path change request to the L-GW 142 (step S816). The HO-source path change request includes, e.g., a target cell ID identifying the cell of the HO-destination base station 123 and the IP address of the terminal 112 (HO terminal) that is to perform HO. The HO-source path change request will be described later (see, e.g., Table 5). The L-GW 142 receiving the HO-source path change request executes the HO-source path change process of changing the communication path at the L-GW 142 for the terminal 112 that is to perform HO (step S817). The HO-source path change process will be described later (see, e.g., FIG. 16).

The terminal 112 receiving the RRC Connection Reconfiguration switches the radio link from the HO-source base station 122 to the HO-destination base station 123 (step S818). The terminal 112 then transmits to the base station 123, RRC Connection Reconfiguration Complete indicating completion of the switching of the radio link (step S819).

The base station 123 receiving the RRC Connection Reconfiguration Complete executes the HO-destination path determination process of determining whether to make a request for path change to the L-GW 143 corresponding to the HO destination (step S820). The HO-destination path determination process will be described later (see, e.g., FIG. 17). In the example depicted in FIG. 8, description is given for a case where it is determined at step S820 that a request for path change is to be made to the L-GW 143.

The base station 123 then transmits the HO-destination path change request to the L-GW 143 (step S821). The HO-destination path change request includes, e.g., a source cell ID identifying the cell of the HO-source base station 122, the IP address of the terminal 112 that is to perform HO, and the IP address of the terminal 111 communicating with the terminal 112. The HO-destination path change request will be described later (see, e.g., Table 6). The base station 123 transmits to the base station 122, UE Context Release for requesting the release of UE context (step S822).

The L-GW 143 receiving the HO-destination path change request executes the HO-destination path change process of changing the communication path in the L-GW 143 for the terminal 111 communicating with the terminal 112 that is to perform HO (step S823). The HO-destination path change process will be described later (see, e.g., FIG. 18). The base station 122 receiving the UE Context Release releases the resource (context) related to the terminal 112 that is to perform HO (step S824).

As a result, for example, as depicted in FIG. 4, communication is restarted (communication is resumed) between the terminal 111 and the terminal 112 through the path passing through the base station 121, the L-GWs 141 to 143, and the base station 123 (step S825).

In the example depicted in FIG. 8, the HO is performed by changing the path at the L-GW 143 at step S823 without disconnecting the shortcut communication between the terminals 111, 112, via the L-GWs. The path change process on the NW side such as at the S-GW 131, the P-GW 132, and the MME 133 is omitted.

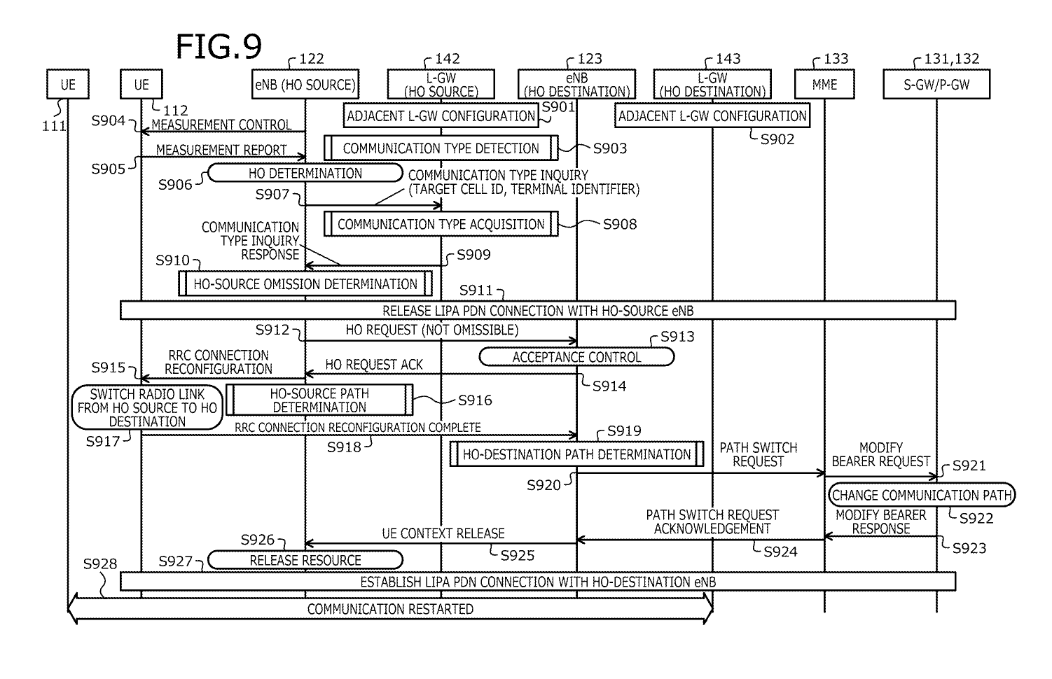

FIG. 9 is a sequence diagram of an example of a process in a case of transmitting an HO request without omitting the path change process on the NW side in the first embodiment. In the example depicted in FIG. 9, the process is described for a case where the HO request is transmitted and the path change process on the NW side is not omitted, when the HO of the terminal 112 is performed from the base station 122 to the base station 123.

Steps S901 to S910 depicted in FIG. 9 are similar to steps S801 to S810 depicted in FIG. 8. However, in the example depicted in FIG. 9, description is given for a case where in the HO-source omission determination process at step S910, it is determined that the HO request is to be transmitted to the base station 123 and that the path change process on the NW side is not to be omitted.

In this case, after step S910, the HO-source base station 122 releases the LIPA PDN connection with the base station 122 (HO-source eNB) (step S911). As a result, the shortcut communication between the terminals 111, 112, via the L-GWs is disconnected.

The base station 122 then transmits the HO request to the HO-destination base station 123 (step S912). In the example depicted in FIG. 9, since it is determined that the path change process on the NW side is not to be omitted in the HO-source omission determination process at step S910, the omission possibility information included in the HO request transmitted at step S912 is information that indicates omission not being possible.

Steps S913 to S916 are similar to steps S812 to S815 depicted in FIG. 8. However, in the example depicted in FIG. 9, because of the omission possibility information that indicates omission not being possible, it is determined that no request for path change is to be made to the L-GW 142 in the HO-source path determination process of step S916 (see, e.g., FIG. 15). In this case, the HO-source path change request depicted in FIG. 8 is not transmitted to the L-GW 142 like at step S816. Therefore, the HO-source path change by the L-GW 142 is not performed like at step S817 depicted in FIG. 8, for example.

Steps S917, S918 are similar to steps S818, S819 depicted in FIG. 8. After step S918, the base station 123 receiving the RRC Connection Reconfiguration Complete executes the HO-destination path determination process (step S919). The HO-destination path determination process will be described later (see, e.g., FIG. 17). In the example depicted in FIG. 9, because of the omission possibility information that indicates omission not being possible, the base station 123 transmits Path Switch Request for requesting a path change to the MME 133 (step S920) so as to change the path of communication via the P-GW 132.

The MME 133 then transmits to the S-GW 131 and the P-GW 132, Modify Bearer Request requesting a path change based on the received Path Switch Request (step S921). The S-GW 131 and the P-GW 132 then change the communication path based on the received Modify Bearer Request (step S922).

The S-GW 131 and the P-GW 132 then transmit to the MME 133, Modify Bearer Response indicating that the communication path has been changed (step S923). The MME 133 then transmits to the base station 123, Path Switch Request Acknowledgement (Path Switch Request ACK) indicating that the path change has been performed (step S924).

The base station 123 receiving the Path Switch Request Acknowledgement transmits to the base station 122, UE Context Release requesting the release of UE context (step S925). The base station 122 receiving the UE Context Release releases the resources related to the terminal 112 that performed HO (step S926), and the HO is completed for the communication via the P-GW 132, for the terminal 112.

It is assumed that the terminal 112 then requests communication via the L-GW, for example. In this case, the LIPA PDN connection with the HO-destination base station 122 (HO-destination eNB) is established (step S927). As a result, for example, as depicted in FIG. 4, communication is restarted (communication is resumed) between the terminal 111 and the terminal 112 through a path passing through the base station 121, the L-GWs 141 to 143, and the base station 123 (step S928). In the example depicted in FIG. 9, the path change process on the NW side such as at the S-GW 131, the P-GW 132, and the MME 133 is executed (e.g., steps S920 to S924).

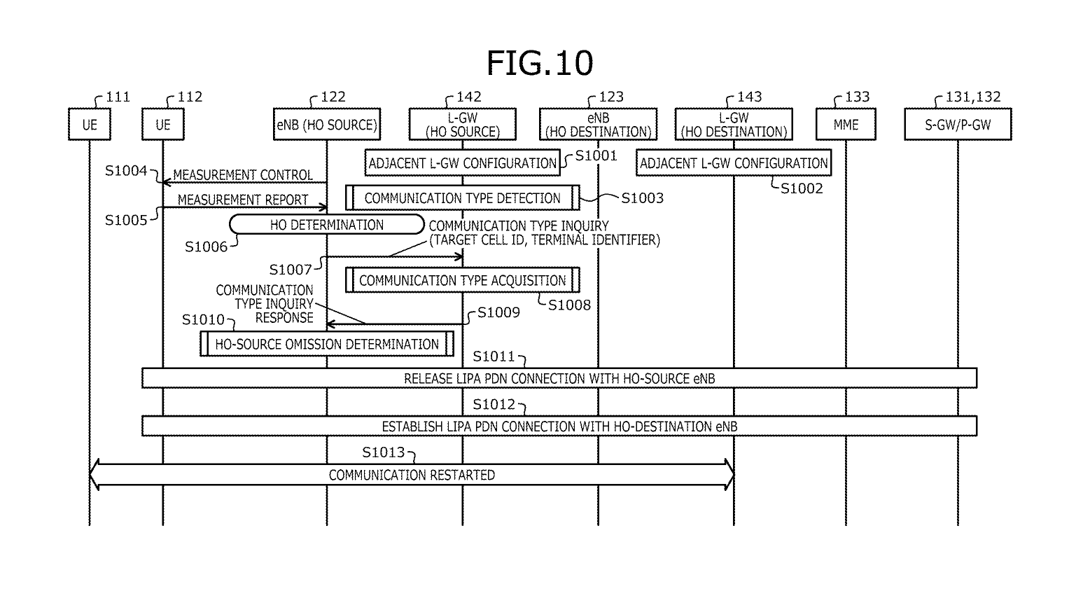

FIG. 10 is a sequence diagram of an example of a process in a case when the HO request is not transmitted in the first embodiment. In the example depicted in FIG. 10, the process is described for a case where the HO request is not transmitted, when the HO of the terminal 112 is performed from the base station 122 to the base station 123.

Steps S1001 to S1010 depicted in FIG. 10 are similar to steps S801 to S810 depicted in FIG. 8. However, in the example depicted in FIG. 10, description is given for a case where it is determined in the HO-source omission determination process at step S1010 that the HO request is not to be transmitted to the base station 123. In this case, after step S1010, the HO-source base station 122 releases the LIPA PDN connection with the base station 122 (HO-source eNB), the LIPA PDN connection being communication via the L-GW 142 (step S1011).

It is assumed that the terminal 112 then requests communication via the L-GW 143, for example. In this case, the LIPA PDN connection with the HO-destination base station 123 (HO-destination eNB) is established (step S1012). As a result, for example, as depicted in FIG. 4, communication is restarted (communication is resumed) between the terminal 111 and the terminal 112 through a path passing through the base station 121, the L-GWs 141 to 143, and the base station 123 (step S1013).

In the example depicted in FIG. 10, since the communication via the P-GW does not exist after the communication via the L-GW is disconnected at step S1011, the execution of the HO sequence is unnecessary. Therefore, the path change process on the NW side such as at the S-GW 131, the P-GW 132, and the MME 133 is not executed.

Table 1 is a table depicting an example of information stored in the inter-L-GW communication path storage unit of the HO-source L-GW 142 according to the first embodiment. For example, as a result of the adjacent L-GW configuration at step S801 depicted in FIG. 8, for example, information related to communication paths between L-GWs described in Table 1 is stored in the inter-L-GW communication path storage unit 516 of the HO-source L-GW 142. In the information related to communication paths between L-GWs described in Table 1, for each L-GW connected to the L-GW 142, the cell ID of the base station corresponding to the L-GW is correlated with the output port of the L-GW 142 connected to the L-GW.

TABLE 1

| Cell ID | Output Port |
|---|---|
| 1 | (3) |
| 3 | (4) |

For example, the L-GW 141 is connected to the L-GW 142 (see, e.g., FIGS. 3 and 4). Therefore, in the information related to communication paths between L-GWs described in Table 1, the cell ID=1 of the base station 121 corresponding to the L-GW 141 is correlated with the output port=(3) of the L-GW 142 connected to the L-GW 141. Since the L-GW 143 is connected to the L-GW 142, the cell ID=3 of the base station 123 corresponding to the L-GW 143 is correlated with the output port=(4) of the L-GW 142 connected to the L-GW 143 in the information related to communication paths between L-GWs described in Table 1.

Table 2 is a table depicting an example of information stored in the inter-L-GW communication path storage unit of the HO-destination L-GW 143 according to the first embodiment. For example, as a result of the adjacent L-GW configuration at step S802 depicted in FIG. 8, for example, information related to communication paths between L-GWs described in Table 2 is stored in the inter-L-GW communication path storage unit 516 of the HO-destination L-GW 143. In the information related to communication paths between L-GWs described in Table 2, for each L-GW connected to the L-GW 143, the cell ID of the base station corresponding to the L-GW is correlated with the output port of the L-GW 143 connected to the L-GW.

TABLE 2

| Cell ID | Output Port |
|---|---|
| 2 | (7) |

For example, the L-GW 142 is connected to the L-GW 143. Therefore, in the information related to communication paths between L-GWs described in Table 2, the cell ID=2 of the base station 122 corresponding to the L-GW 142 is correlated with the output port=(7) of the L-GW 143 connected to the L-GW 142.

Table 3 is a table depicting an example of the communication type inquiry according to the first embodiment. For example, at step S807 depicted in FIG. 8, the HO-source base station 122 transmits to the L-GW 142, a communication type inquiry described in Table 3. The communication type inquiry described in Table 3 includes an identifier of the terminal 112 that is to perform HO and a target cell ID identifying the cell of the HO-destination base station 123.

TABLE 3

Identifier of Terminal to Perform HO
Target Cell ID

Table 4 is a table depicting an example of the communication type inquiry response according to the first embodiment. For example, at step S809 depicted in FIG. 8, the L-GW 142 transmits to the base station 122, a communication type inquiry response described in Table 4. The communication type inquiry response described in Table 4 includes a communication type, possibility of direct communication between L-GWs, the IP address of the terminal 112 that is to perform HO, and the IP address of the terminal 111 communicating with the terminal 112.

TABLE 4
Communication Type (Whether L-GW Shortcut Communication is
Possible)
Possibility of Direct Communication Between L-GWs
IP Address of Terminal to Perform HO
IP Address of Terminal Communicating with Terminal to Perform HO

The communication type is information that indicates whether the L-GW shortcut communication is possible. This communication type is the information acquired at step S1302 depicted in FIG. 13, for example. The possibility of direct communication between L-GWs is information that indicates whether direct communication between L-GWs is possible. The possibility of direct communication between L-GWs is determined at step S1304 or step S1305 depicted in FIG. 13.

FIG. 11 is a diagram of an example of the HO request according to the first embodiment. For example, at step S811 depicted in FIG. 8, the base station 122 transmits to the base station 123 an HO request 1100 depicted in FIG. 11, for example. The HO request 1100 is an HO request having omission possibility information 1101, an S5 tunnel endpoint identifier 1102 (S5 TEID), IP addresses 1103, 1104, and source cell ID 1105 added to “X2 AP: HANDOVER REQUEST” specified by 3GPP.

The omission possibility information 1101 is information notifying the HO destination of whether the path change on the NW side can be omitted. The S5 tunnel endpoint identifier 1102 is information for generating a path between the HO-destination base station 123 and the L-GW 143.

The IP addresses 1103, 1104 and the source cell ID 1105 are information for establishing a direct communication path between the HO-source L-GW 142 and the HO-destination L-GW 143. For the IP address 1103, the IP address=B of the terminal 112 that is to perform HO is stored. For the IP address 1104, the IP address=A of the terminal 111 communicating with the terminal 112 that is to perform HO is stored. For the source cell ID 1105, the ID=2 of the cell of the HO-source base station 122 is stored.

As described above, the HO request 1100 includes the omission possibility information 1101 depending on whether the communication of the terminal 112 is the L-GW shortcut communication (whether the communication passes through the local network 102). The HO request transmitted at step S811 depicted in FIG. 8 is not limited to the HO request 1100 depicted in FIG. 11, and control signals in various formats can be used.

Table 5 is a table depicting an example of the HO-source path change request according to the first embodiment. For example, at step S816 depicted in FIG. 8, the base station 122 transmits to the L-GW 142, an HO-source path change request described in Table 5. The HO-source path change request described in Table 5 includes a target cell ID identifying the cell of the HO-destination base station 123 and the IP address of the terminal 112 that is to perform HO.

TABLE 5

Target Cell ID
IP Address of Terminal to Perform HO

Table 6 is a table depicting an example of the HO-destination path change request according to the first embodiment. For example, at step S821 depicted in FIG. 8, the base station 123 transmits to the L-GW 143, an HO-destination path change request described in Table 6. The HO-destination path change request described in Table 6 includes a source cell ID identifying the cell of the HO-source base station 122, the IP address of the terminal 112 that is to perform HO, and the IP address of the terminal 111 communicating with the terminal 112 that is to perform HO.

TABLE 6
Source Cell ID
IP Address of Terminal to Perform HO
IP Address of Terminal Communicating with Terminal to Perform HO

FIG. 12 is a flowchart of an example of the communication type detection process according to the first embodiment. For example, at step S803 depicted in FIG. 8, for example, the L-GW 142 executes steps depicted in FIG. 12 as the communication type detection process.

First, the L-GW 142 sets a direction attribute for each port of the L-GW 142 (step S1201). The setting of the direction attribute for each port will be described later (see, e.g., Table 7). Step S1201 can be executed by reading the setting made at the time of deployment of the L-GW 142, for example.

The L-GW 142 then stores to the NW-side path storage unit 512, information indicating relationships between a destination IP address and an output port (step S1202). The setting of a destination IP address and an output port to the NW-side path storage unit 512 will be described later (see, e.g., Table 8). Step S1202 can be executed by reading information set at the start of communication between the terminal 111 and the terminal 112, for example.

When receiving a packet for which the destination or source is the terminal 112, the L-GW 142 acquires the destination IP address and the source IP address of the received packet (reception packet) (step S1203). The L-GW 142 then determines whether the direction attribute of the output port corresponding to the destination IP address acquired at step S1203 is the NW direction (step S1204).

In a case where the direction attribute of the output port corresponding to the destination IP address is the NW direction at step S1204 (step S1204: YES), it can be determined that the communication in the terminal 112 passes through the local network 102. In this case, the L-GW 142 sets the non-L-GW shortcut communication as the communication type of the terminal 112 (step S1205) and goes to step S1208. In a case where the direction attribute of the output port corresponding to the destination IP address is not the NW direction (step S1204: NO), the L-GW 142 goes to step S1206.

The L-GW 142 determines whether the direction attribute of the output port corresponding to the source IP address acquired at step S1203 is the NW direction (step S1206). In a case where the direction attribute is the NW direction (step S1206: YES), it can be determined that the communication in the terminal 112 passes through the local network 102. In this case, the L-GW 142 goes to step S1205.

In a case where the direction attribute is not the NW direction at step S1206 (step S1206: NO), it can be determined that the communication in the terminal 112 does not pass through the local network 102. In this case, the L-GW 142 sets the L-GW shortcut communication as the communication type of the terminal 112 (step S1207).

The L-GW 142 then stores in a correlated manner in the communication type storage unit 515, the communication type set at step S1205 or S1207 and the destination and source IP addresses acquired at step S1203 (step S1208). The L-GW 142 then terminates the series of processes.

As described above, the L-GW 142 determines whether among the communication ports, a communication port corresponding to at least one of the destination and source of data in the communication of the terminal 112 via the L-GW 142 is connected to the local network 102. As a result, it can be determined whether the communication of the terminal 112 via the L-GW 142 passes through the local network 102 (whether the communication is the non-L-GW shortcut communication or the L-GW shortcut communication).

Table 7 is a table depicting an example of information stored in the port direction attribute storage unit of the HO-source L-GW 142 according to the first embodiment. For example, at step S1201 depicted in FIG. 12, port direction attribute information described in Table 7 is stored in the port direction attribute storage unit 514 of the L-GW 142 corresponding to the HO source. In the port direction attribute information described in Table 7, direction attributes are correlated with the respective output ports of the L-GW 142.

TABLE 7

| Output Port | Direction Attribute |
|---|---|
| (1) | UE Direction |
| (2) | NW Direction |
| (3) | L-GW Direction |
| (4) | L-GW Direction |

The direction attribute is information that indicates the transmission destination corresponding to the output port. In the example described in Table 7, the direction attribute includes the UE direction when UE such as the terminal 112 is the transmission destination, the L-GW direction when another L-GW such as the L-GWs 141, 143 is the transmission destination, and the NW direction when the local network 102 is the transmission destination. Since the L-GW 142 transmits a packet through the base station 122 to the terminal 112, the direction attribute of the output port connected to the base station 122 is also the UE direction.

For example, as depicted in FIGS. 3 and 4, since the output port=(1) of the L-GW 142 is connected to the base station 122, the direction attribute of the output port=(1) is the UE direction. Since the output port=(2) of the L-GW 142 is connected to the local network 102, the direction attribute of the output port=(2) is the NW direction. Since the output port=(3) of the L-GW 142 is connected to the L-GW 141, the direction attribute of the output port=(3) is the L-GW direction. Since the output port=(4) of the L-GW 142 is connected to the L-GW 143, the direction attribute of the output port=(4) is the L-GW direction.

Table 8 is a table depicting an example of information stored in the NW-side path storage unit of the HO-source L-GW 142 according to the first embodiment. For example, at step S1202 depicted in FIG. 12, NW-side path information described in Table 8 is stored to the NW-side path storage unit 512 of the HO-source L-GW 142. In the NW-side path information described in Table 8, the output ports of the L-GW 142 are correlated with respective destination IP addresses.

TABLE 8

| Destination IP Address | Output Port |
|---|---|
| A | (3) |
| B | (1) |
| C | (2) |
| D | |

For example, as depicted in FIGS. 3 and 4, since the destination IP address=A is the address of the terminal 111, the output port=(3) corresponding to the direction of the terminal 111 (the base station 121) is correlated with the destination IP address=A. Since the destination IP address=B is the address of the terminal 112, the output port=(1) corresponding to the direction of the terminal 112 (the base station 122) is correlated with the destination IP address=B.

Since the destination IP address=C is the address of the server 301, the output port=(2) corresponding to the direction of the server 301 (the local network 102) is correlated with the destination IP address C. Since the destination IP address=D is the address of the server 302, the output port=(2) corresponding to the direction of the server 302 (the local network 102) is correlated with the destination IP address=D.

Table 9 is a diagram of an example of information stored in the communication type storage unit of the HO-source L-GW 142 according to the first embodiment. For example, at step S1208 depicted in FIG. 12, communication type information described in Table 9 is stored to the communication type storage unit 515 of the HO-source L-GW 142. In the communication type information described in Table 9, the source IP address, the destination IP address, and the communication type are correlated with each other.

TABLE 9

| Source IP Address | Destination IP Address | Communication Type |
|---|---|---|
| A | B | L-GW Shortcut |
| | | Communication |

For example, at step S1203 depicted in FIG. 12, it is assumed that the L-GW 142 receives a packet having the IP address=A of the terminal 111 as the source and the IP address=B of the terminal 112 as the destination. In this case, the output port corresponding to IP address=A is the output port=(3) (see Table 8) and the direction attribute of the output port=(3) is the L-GW direction (see Table 7). The output port corresponding to the IP address=B is the output port=(1) (see Table 8), and the direction attribute of the output port=(1) is the UE direction (see Table 7).

Therefore, the L-GW 142 sets the L-GW shortcut communication as the communication type of the received packet. Thus, as described in the communication type information of Table 9, the L-GW 142 stores the source IP address=A, the destination IP address=B, and the communication type=L-GW shortcut communication in a correlated manner in the communication type storage unit 515.

FIG. 13 is a flowchart of an example of the communication type acquisition process by the HO-source L-GW 142 according to the first embodiment. For example, at step S808 depicted in FIG. 8, the HO-source L-GW 142 executes steps depicted in FIG. 13 as the communication type acquisition process.

First, the L-GW 142 converts the identifier of the terminal that is to perform HO (the terminal 112) into an IP address (step S1301). The terminal identifier is information included in the communication type inquiry described in Table 3 and capable of identifying the IP address of the terminal that is to perform HO (the terminal 112).

The L-GW 142 then refers to the communication type storage unit 515 based on the IP address of the terminal 112 converted at step S1301 to acquire the IP address and the communication type of the communication counterpart of the terminal 112 (step S1302). For example, in the example described in Table 9, the IP address=B of the terminal 112 is correlated with the IP address=A of the terminal 111. Therefore, at step S1302, the IP address=A of the terminal 111 is acquired as the IP address of the communication counterpart of the terminal 112.

The L-GW 142 then determines whether the target cell ID of the HO-destination base station 123 of the terminal 112 exists in the inter-L-GW communication path storage unit 516 (step S1303). The target cell ID is information included in the communication type inquiry described in Table 3. For example, in the example described in Table 1, the cell ID=3 of the HO-destination base station 123 of the terminal 112 exists in the information related to communication paths between L-GWs.

In a case where it is determined at step S1303 that the target cell ID exists (step S1303: YES), the L-GW 142 determines that the direct communication between L-GWs is possible (step S1304) and terminates the series of processes. In a case where it is determined that the target cell ID does not exist (step S1303: NO), the L-GW 142 determines that the direct communication between L-GWs is impossible (step S1305) and terminates the series of processes.

FIG. 14 is a flowchart of an example of the HO-source omission determination process according to the first embodiment. At steps S810, S811 depicted in FIG. 8, for example, the HO-source base station 122 executes steps depicted in FIG. 14 as the HO-source omission determination process and transmission of an HO-request.

First, the base station 122 determines whether direct communication between L-GWs is possible, based on the communication type inquiry response received from the L-GW 142 (step S1401). Direct communication between L-GWs is direct communication between the L-GW 142 and the L-GW 143. In a case where direct communication between L-GWs is not possible (step S1401: NO), the base station 122 goes to step S1406. In a case where direct communication between L-GWs is possible (step S1401: YES), the base station 122 determines whether bearers performing communication in the terminal 112 that is to perform HO include a bearer passing through the P-GW 132 (step S1402).

At step S1402, in a case where a bearer passing through the P-GW 132 is included (step S1402: YES), the base station 122 goes to step S1406. In a case where a bearer passing through the P-GW 132 is not included (step S1402: NO), the base station 122 determines whether the communication type is the L-GW shortcut communication (step S1403).

At step S1403, in a case where the communication type is the L-GW shortcut communication (step S1403: YES), the base station 122 sets the omission possibility information to omissible in the omission possibility storage unit 721 (step S1404). The base station 122, without releasing the LIPA PDN connection for the terminal 112, then transmits to the HO-destination base station 123 (HO-destination eNB), a HO request including the omission possibility information that indicates omissible (step S1405) and terminates the series of processes. This case corresponds to the process depicted in FIG. 8, for example.

At step S1403, in a case where the communication type is not the L-GW shortcut communication (step S1403: NO), the base station 122 releases the LIPA PDN connection for the terminal 112 (step S1406). The base station 122 then determines whether the bearers performing communication in the terminal 112 that is to perform HO include a bearer passing through the P-GW 132 (step S1407).

In a case where a bearer passing through the P-GW 132 is not included at step S1407 (step S1407: NO), the base station 122 terminates the series of processes without transmitting the HO request. This case corresponds to the process depicted in FIG. 10, for example.

In a case where a bearer passing through the P-GW 132 is included (step S1407: YES), the base station 122 sets the omission possibility information in the omission possibility storage unit 721 to not omissible (step S1408). The base station 122 then transmits to the HO-destination base station 123 (HO-destination eNB), a HO request including the omission possibility information that indicates not omissible (step S1409) and terminates the series of processes. This case corresponds to the process depicted in FIG. 9, for example.

As described above, in a case where the L-GW 142 and the L-GW 143 can directly communicate, the bearers performing communication in the terminal 112 that is to perform HO do not include communication via the P-GW, and the terminal 112 is the terminal performing the L-GW shortcut communication, the base station 122 sets the omission possibility information to omissible. Therefore, in this case, the base station 122 does not release the LIPA PDN connection and instructs the HO-destination base station 123 to omit the path change process on the NW side at the HO destination.

FIG. 15 is a flowchart of an example of the HO-source path determination process and transmission of an HO-source path establishment request according to the first embodiment. For example, at step S815 depicted in FIG. 8, the HO-source base station 122 executes steps depicted in FIG. 15 as the HO-source path determination process.

First, the base station 122 determines whether the omission possibility information is set to omissible in the omission possibility storage unit 721 by the HO-source omission determination process depicted in FIG. 14 (step S1501). In a case where the omission possibility information is set to omissible (step S1501: YES), the base station 122 transmits a HO-source path establishment request to the HO-source L-GW 142 (step S1502). This case corresponds to the process depicted in FIG. 8, for example. In a case where the omission possibility information is not set to omissible (step S1501: NO), the base station 122 terminates the series of processes without transmitting a HO-source path establishment request. This case corresponds to the process depicted in FIG. 9, for example.

FIG. 16 is a flowchart of an example of the HO-source path change process according to the first embodiment. For example, at step S817 depicted in FIG. 8, the HO-source L-GW 142 executes steps depicted in FIG. 16 as the HO-source path change process.

First, the L-GW 142 refers to the inter-L-GW communication path storage unit 516 to convert the target cell ID of the HO destination included in the HO-source path change request from the base station 122 into the port number (step S1601). In the NW-side path storage unit 512, the L-GW 142 changes the output port corresponding to the IP address of the terminal 112 that is to perform HO, to the port number after the conversion at step S1601 (step S1602) and terminates the series of processes.

For example, since the HO destination is the base station 123 and has the target cell ID=3, the output port=(4) corresponding to the base station 123 is acquired at step S1601 (see, e.g., Table 1). At step S1602, in the example described in Table 8, the output port=(1) corresponding to the IP address=B of the terminal 112 is changed to the output port=(4) in the NW-side path information. Subsequently, the L-GW 142 outputs a packet having the destination IP address B from the output port=(4). As a result, the packet to the terminal 112 received by the L-GW 142 is transferred to the L-GW 143.

FIG. 17 is a flowchart of an example of the HO-destination path determination process and a process based on the HO-destination path determination process according to the first embodiment. For example, at step S820 depicted in FIG. 8, the HO-destination base station 123 executes steps depicted in FIG. 17 as the HO-destination path determination process.

First, the base station 123 determines whether the omission possibility information included in the HO request received from the base station 122 is set to omissible (step S1701). In a case where the omission possibility information is set to omissible (step S1701: YES), the base station 123 transmits an HO-destination path establishment request to the HO-destination L-GW 143 (step S1702). The base station 123 then transmits a UE context release to the HO-source base station 122 (HO-source eNB) (step S1703) and terminates the series of processes. This case corresponds to the process depicted in FIG. 8, for example.

In a case where the omission possibility information is not set to omissible at step S1701 (step S1701: NO), the base station 123 transmits a path switch request to the MME 133 (step S1704) and terminates the series of processes. This case corresponds to the process depicted in FIG. 9, for example.

FIG. 18 is a flowchart of an example of the HO-destination path change process according to the first embodiment. For example, at step S823 depicted in FIG. 8, the HO-destination L-GW 143 executes steps depicted in FIG. 18 as the HO-destination path change process.

First, the L-GW 143 sets the output port corresponding to the IP address=B of the terminal 112 that is to perform HO, to the UE direction (step S1801). The L-GW 143 then refers to the inter-L-GW communication path storage unit 516 to convert the source cell ID included in the HO-destination path change request from the base station 123 into the port number (step S1802).

The L-GW 143 then changes, in the NW-side path storage unit 512, the output port corresponding to the IP address of the terminal 111 communicating with the terminal 112 that is to perform HO, to the port number after the conversion at step S1802 (step S1803) and terminates a series of processes.

For example, since the HO source is the base station 122 and has the source cell ID=2, the output port=(7) corresponding to the base station 122 is acquired at step S1802 (see, e.g., FIGS. 3 and 4). At step S1803, the output port corresponding to the IP address=A of the terminal 111 is changed to the output port=(7) in the NW-side path information of the NW-side path storage unit 512 in the L-GW 143. Subsequently, the L-GW 143 outputs from the output port=(7), a packet having the destination IP address A. As a result, the packet to the terminal 111 received by the L-GW 143 is transferred to the L-GW 142.

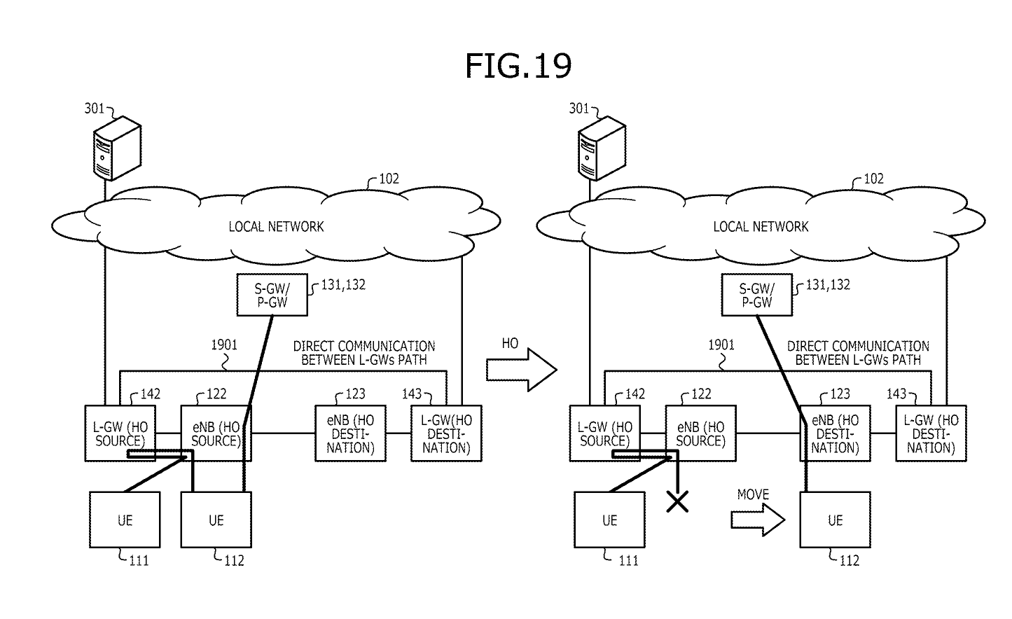

FIG. 19 is a diagram of an example of a change in communication path due to HO when the HO request is transmitted and the path change process on the NW side is not omitted in the first embodiment. In FIG. 19, parts similar to those depicted in FIGS. 3 and 4 are denoted by the same reference numerals used in FIGS. 3 and 4, and will not be described. In the process described with reference to FIG. 19, as in the example depicted in FIG. 9, when the HO of the terminal 112 is performed from the base station 122 to the base station 123, the HO request is transmitted and the path change process on the NW side is not omitted.

In the example depicted in FIG. 19, the terminals 111, 112 are both connected to the base station 122, and the communication between the terminals 111, 112 is performed through a path shortcut at the L-GW 142 without passing through the local network 102. Direct communication between L-GWs path 1901 can be established. The terminal 112 is also performing communication via the S-GW 131 and the P-GW 132.

In this case, when the HO of the terminal 112 occurs from the base station 122 to the base station 123 due to the movement of the terminal 112, since the communication via the L-GW and the communication via the P-GW are present, the communication via the L-GW is disconnected and the HO of the communication via the P-GW is performed (see FIG. 14). Therefore, in this case, the path change process on the NW side is executed (see FIG. 9).

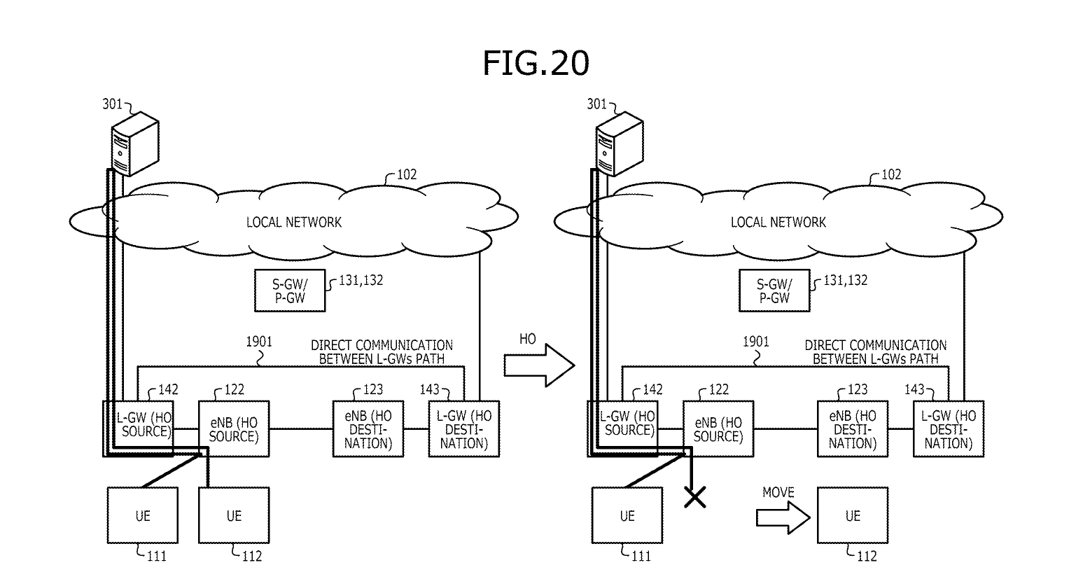

FIG. 20 is a diagram of an example of a change in communication path due to HO when the HO request is not transmitted in the first embodiment. In FIG. 20, parts similar to those depicted in FIGS. 3 and 4 are denoted by the same reference numerals used in FIGS. 3 and 4, and will not be described. In the process described with reference to FIG. 20, as in the example depicted in FIG. 10, when the HO of the terminal 112 is performed from the base station 122 to the base station 123, the HO request is not transmitted.

In the example depicted in FIG. 20, the terminals 111, 112 are both connected to the base station 122, and the non-shortcut communication between the terminals 111, 112 is performed through the L-GW 142, the local network 102, and the server 301. On the other hand, unlike the example depicted in FIG. 19, the terminal 112 is not communicating via the S-GW 131 and the P-GW 132 (communicating via the P-GW).

In this case, when the HO of the terminal 112 occurs from the base station 122 to the base station 123 due to the movement of the terminal 112, since only the communication via the L-GW is present and is non-shortcut communication, the communication via the L-GW is disconnected (see FIG. 14). In this case, since no communication via the P-GW is present in the terminal 112, the HO sequence itself is unnecessary (see FIG. 10).

Therefore, for example, when the terminal 112 requests communication via the L-GW 143 again, the LIPA PDN connection is established, and the communication between the terminals 111, 112 can be resumed.

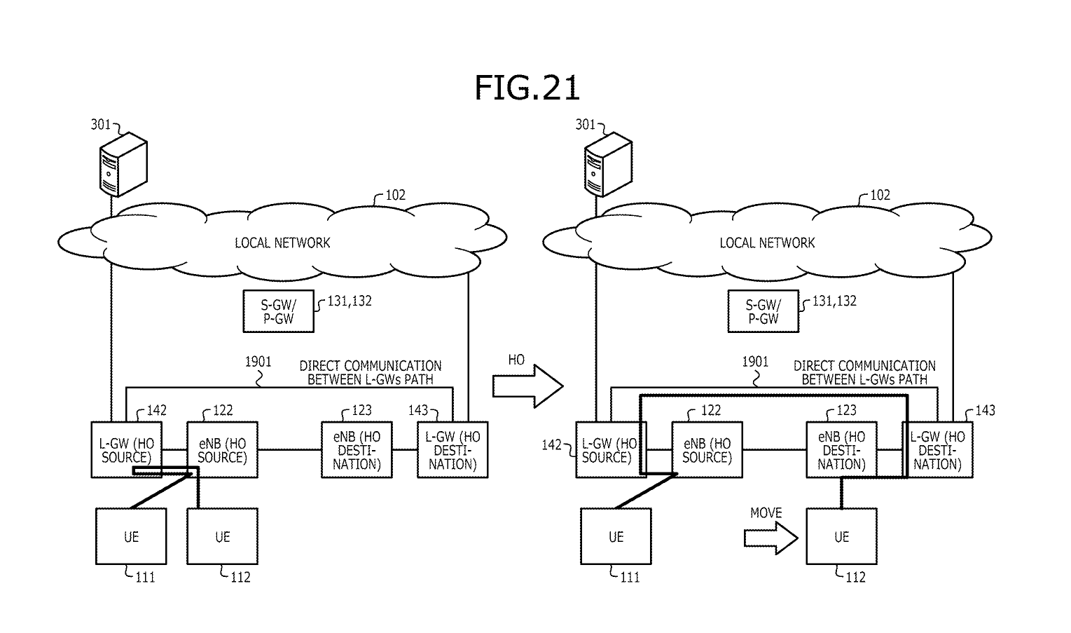

FIG. 21 is a diagram of an example of a change in communication path due to HO when the HO request is transmitted and the path change process on the NW side is omitted in the first embodiment. In FIG. 21, parts similar to those depicted in FIGS. 3 and 4 are denoted by the same reference numerals used in FIGS. 3 and 4, and will not be described. In the process described with reference to FIG. 21, as in the example depicted in FIG. 8, when the HO of the terminal 112 is performed from the base station 122 to the base station 123, the HO request is transmitted.

In the example depicted in FIG. 21, the terminals 111, 112 are both connected to the base station 122, and the communication between the terminals 111, 112 is performed through a path shortcut at the L-GW 142 . Direct communication between L-GWs path 1901 can be established. The terminal 112 is not communicating via the S-GW 131 and the P-GW 132 (communicating via the P-GW).

In this case, when the HO of the terminal 112 occurs from the base station 122 to the base station 123 due to the movement of the terminal 112, since only the communication via the L-GW is present and is shortcut communication, the communication via the L-GW is not disconnected. Direct communication between L-GWs path 1901 between the L-GWs 142, 143 is established, and the HO is performed and the path change process on the NW side is omitted (see FIG. 8).

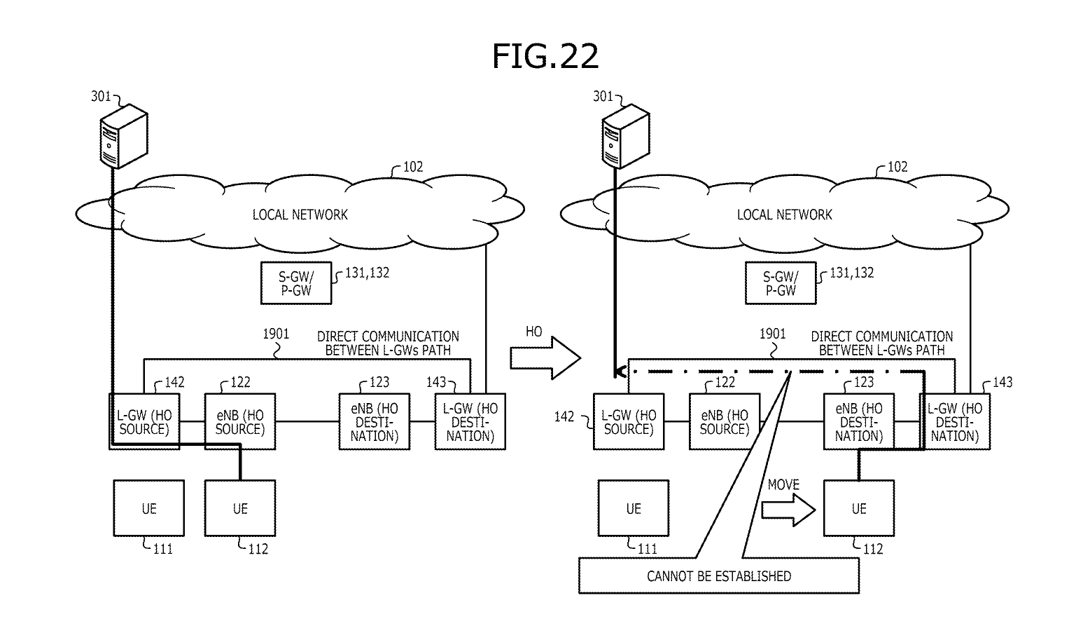

FIG. 22 is a reference diagram of an example when the path change process is omitted at the time of HO in non-shortcut communication. In FIG. 22, parts similar to those depicted in FIGS. 3 and 4 are denoted by the same reference numerals used in FIGS. 3 and 4, and will not be described. In FIG. 22, description will be made for a case where the HO of the terminal 112 is performed to the base station 123 when the terminal 112 is communicating with the server 301 through the base station 122, the L-GW 142, and the local network 102.

In this case, if it is attempted to apply the process of transmitting the HO request and omitting the path change process on the NW side as depicted in FIG. 21, the direct communication between L-GWs path cannot be established in the direction from the HO-destination L-GW 143 to the HO-source L-GW 142. This is because the L-GWs 142, 143 do not recognize the IP address of the server 301.

Although a case of the terminal 112 communicating with the server 301 has been described with reference to FIG. 22, the same applies in a case where the terminal 112 is communicating with the terminal 111 through the server 301. Therefore, if only the communication via the L-GW is present and is non-shortcut communication, as depicted in FIG. 20, the process of disconnecting the communication via the L-GW is executed. Thus, for example, when the terminal 112 requests the communication via the L-GW again, the LIPA PDN connection is established and the communication between the terminals 111, 112 can be resumed.

As described above, in the wireless communications system 100 according to the first embodiment, it is determined whether the communication between terminals at the HO-object terminal 112 is the shortcut communication via the L-GW. In the case of the shortcut communication via the L-GW, the HO can be performed without disconnecting the communication via the L-GW. By performing the HO without disconnecting the communication via the L-GW (see, e.g., FIGS. 8 and 21), the instantaneous interruption time at HO can be reduced.

A second embodiment will be described in terms of parts different from the first embodiment. Although an L-GW and a base station are provided as physically separated apparatuses in the configuration described in the first embodiment, an L-GW and an eNB are provided as a physically integrated apparatus in the configuration described in the second embodiment.

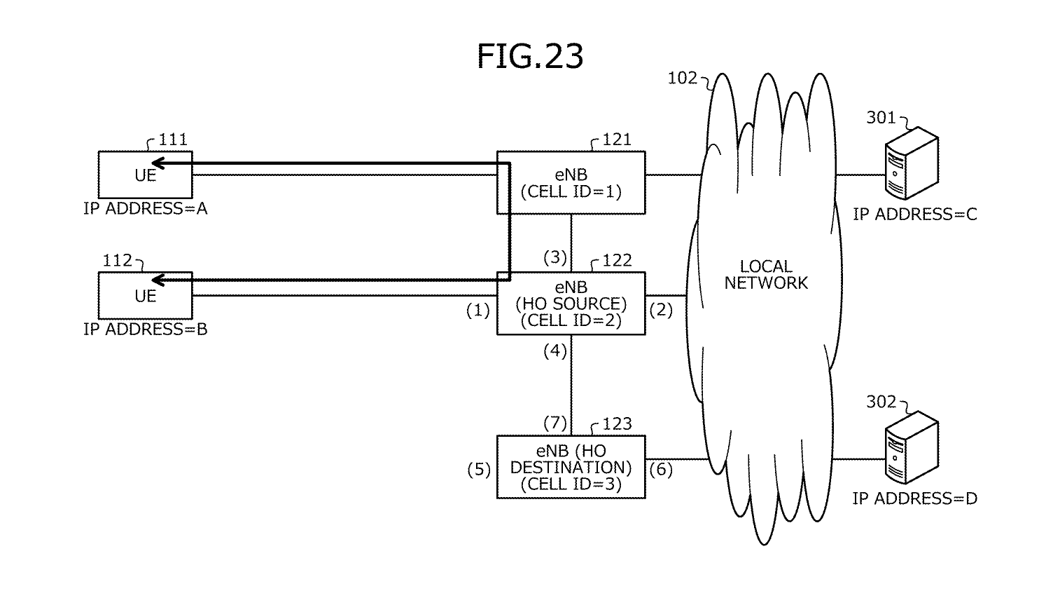

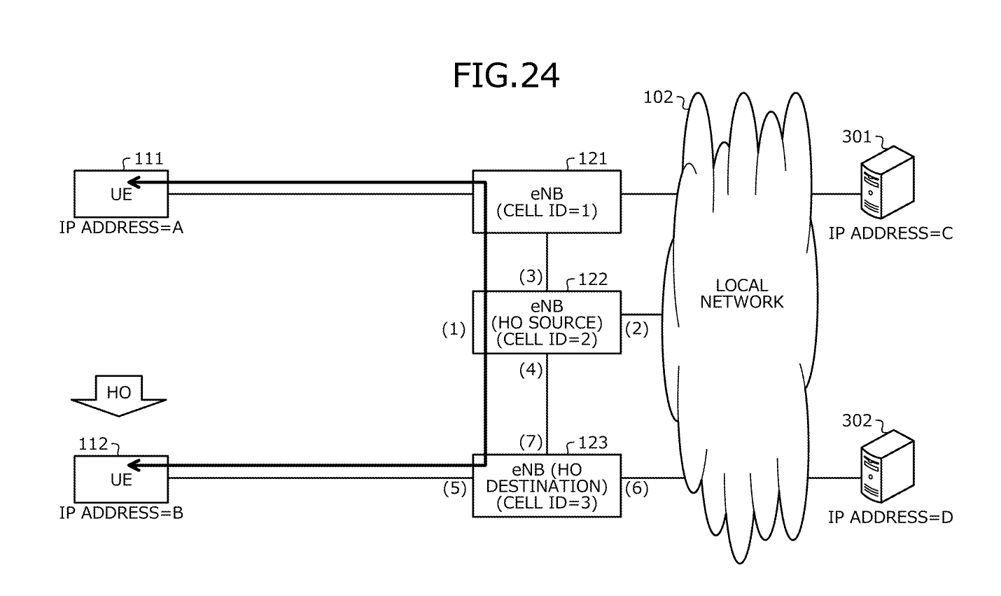

FIGS. 23 and 24 are diagrams of examples of the configuration of L-GWs and HO according to the second embodiment. In FIGS. 23 and 24, parts similar to those depicted in FIGS. 3 and 4 are denoted by the same reference numerals used in FIGS. 3 and 4, and will not be described. In the examples depicted in FIGS. 23 and 24, the functions of the L-GWs 141 to 143 are provided in the base stations 121 to 123, respectively.

First, as depicted in FIG. 23, it is assumed that the terminals 111, 112 are connected to the base stations 121, 122, respectively, and that communication is performed between the terminals 111, 112 through a data path passing through the base station 121 and the base station 122. Subsequently, as depicted in FIG. 24, it is assumed that HO of the terminal 112 has occurred from the base station 122 to the base station 123 due to movement, etc. of the terminal 112. As a result, communication is performed between the terminals 111, 112 through a data path passing through the base stations 121 to 123.

In FIGS. 23 and 24, (1) to (4) denote numbers of output ports in the HO-source base station 122. For example, (1) denotes the number of the output port (UE direction) connected to the terminal side, in the base station 122, i.e., the output port of wireless communication; (2) denotes the number of the output port (NW direction) connected to the local network 102, in the base station 122; (3) denotes the number of the output port (eNB direction) connected to the base station 121, in the base station 122; and (4) denotes the number of the output port (eNB direction) connected to the base station 123 in the base station 122.

In FIGS. 23 and 24, (5) to (7) denote numbers of output ports in the HO-destination base station 123. For example, (5) denotes the number of the output port (UE direction) connected to the terminal side, in the base station 123, i.e., the output port of wireless communication; (6) denotes the number of the output port (NW direction) connected to the local network 102, in the base station 123; and (7) denotes the number of the output port (eNB direction) connected to the base station 122, in the base station 123.

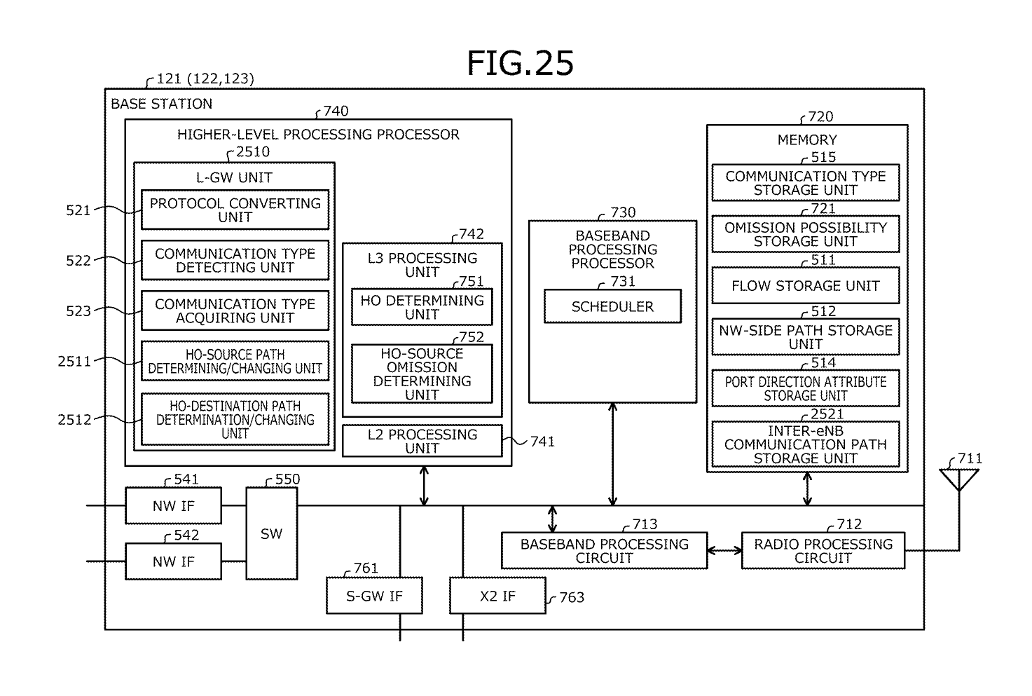

FIG. 25 is a diagram of an example of the base station according to the second embodiment. In FIG. 25, parts similar to those depicted in FIGS. 5 and 7 are denoted by the same reference numerals used in FIGS. 5 and 7, and will not be described. Although the configuration of the base station 121 will be described with reference to FIG. 25, the configurations of the base stations 122, 123 are similar to the configuration of the base station 121.

As depicted in FIG. 25, configuration of the base station 121 according to the second embodiment includes the configuration of the base station 121 depicted in FIG. 7 in addition to the configuration of the L-GW 141 depicted in FIG. 5. However, the base station interface 530 depicted in FIG. 5 may be omitted in the base station 121. Therefore, the base station 121 includes network interfaces 541, 542 and a switch 550 in addition to the configuration of the base station 121 depicted in FIG. 7.

In the memory 720 of the base station 121, an inter-eNB communication path storage unit 2521 is implemented in addition to the configuration depicted in FIG. 7. The inter-eNB communication path storage unit 2521 is a storage unit corresponding to the inter-L-GW communication path storage unit 516 depicted in FIG. 5. Information stored in the inter-eNB communication path storage unit 2521 will be described later (see, e.g., Tables 10 and 11).

In the higher-level processing processor 740 of the base station 121, an L-GW unit 2510 corresponding to the function of the L-GW 141 is implemented in addition to the L3 processing unit 742 depicted in FIG. 7. The L-GW unit 2510 includes the protocol converting unit 521, the communication type detecting unit 522, the communication type acquiring unit 523 depicted in FIG. 5, an HO-source path determining/changing unit 2511, and an HO-destination path determination/changing unit 2512.

The HO-source path determining/changing unit 2511 has functions of the HO-source path determining unit 753 depicted in FIG. 7 and the HO-source path changing unit 524 depicted in FIG. 5. The HO-destination path determination/changing unit 2512 has functions of the HO-destination path determining unit 754 depicted in FIG. 7 and the HO-destination path changing unit 525 depicted in FIG. 5.

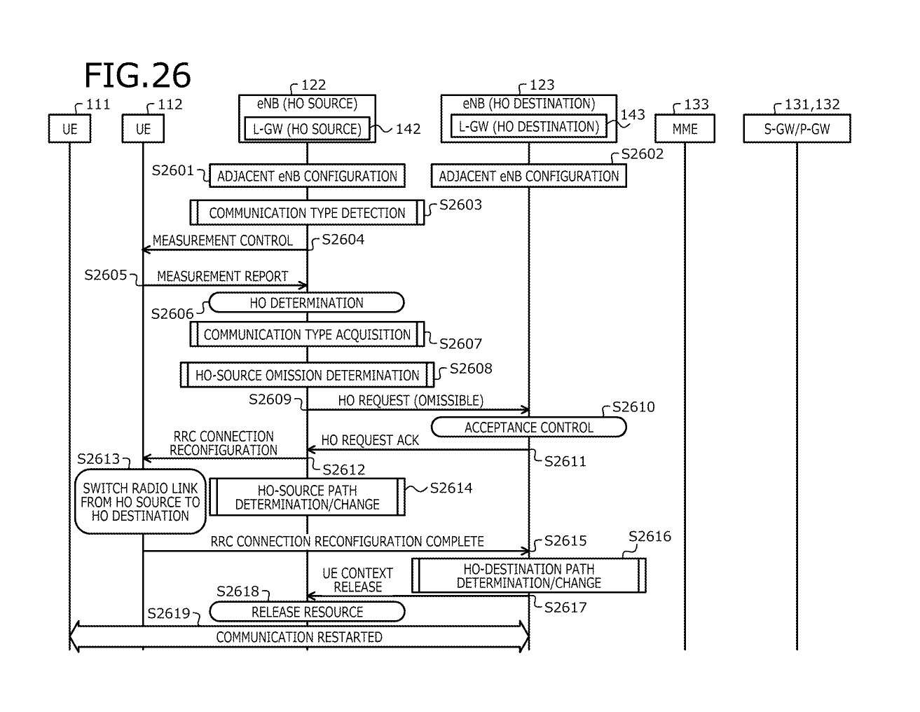

FIG. 26 is a sequence diagram of an example of a process in a case of transmitting an HO request and omitting a path change process in the second embodiment. In the wireless communications system 100 according to the second embodiment, for example, steps depicted in FIG. 26 are executed. In the example depicted in FIG. 26, description is given for a case where the HO request is transmitted and the path change process is omitted, when the HO of the terminal 112 is performed from the base station 122 to the base station 123.

Steps S2601 to S2619 depicted in FIG. 26 are similar to steps S801 to S825 depicted in FIG. 8. However, in the second embodiment, since functions of the L-GW 142 are provided in the base station 122, steps S2601 and S2602 are adjacent eNB configuration rather than the adjacent L-GW configuration.

The processes by the L-GW 142 depicted in FIG. 8 are executed by the base station 122. The communication between the base station 122 and the L-GW 142 depicted in FIG. 8 is not performed. In the second embodiment, since functions of the L-GW 143 are provided in the base station 123, the processes by the L-GW 143 depicted in FIG. 8 are executed by the base station 123. The communication between the base station 123 and the L-GW 143 depicted in FIG. 8 is not performed.

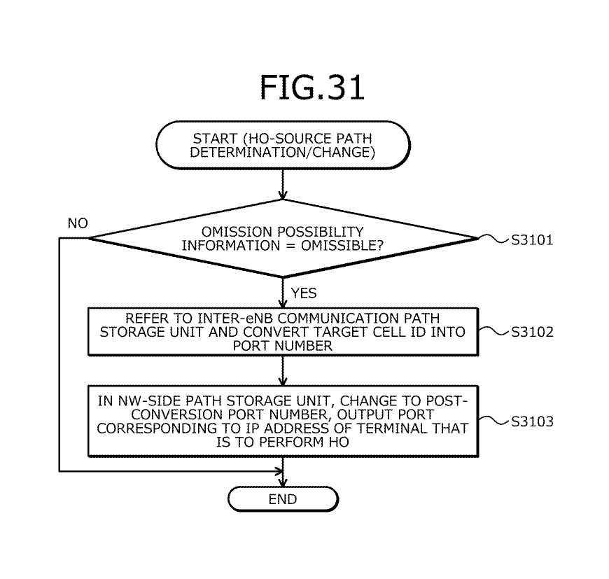

A HO-source path determination/change process at step S2614 is a process integrating the HO-source path determination process by the base station 122 at step S815 and the HO-source path change process by the L-GW 142 at step S817 depicted in FIG. 8. The HO-source path determination/change process will be described later (see, e.g., FIG. 31).

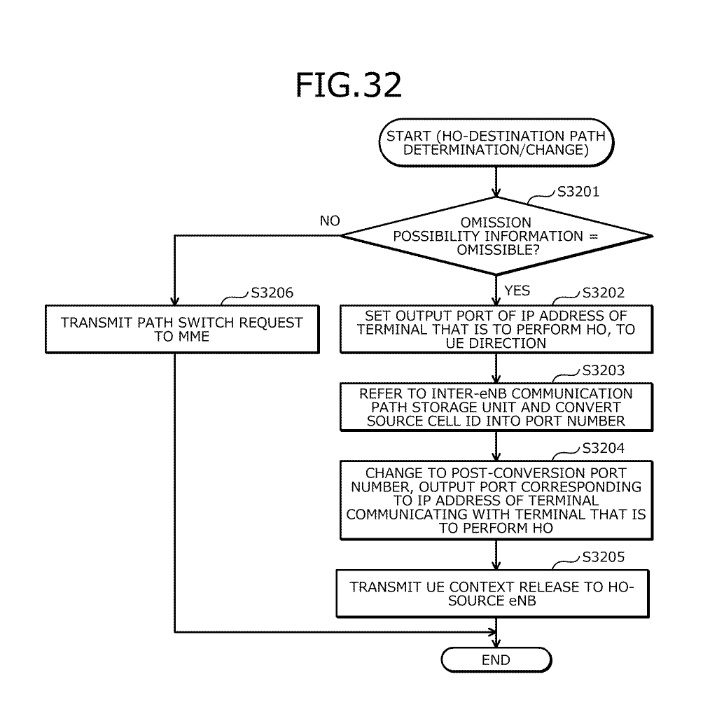

A HO-destination path determination/change process at step S2616 is a process integrating the HO-destination path determination process by the base station 123 at step S820 and the HO-destination path change process by the L-GW 143 at step S823 depicted in FIG. 8. The HO-destination path determination/change process will be described later (see, e.g., FIG. 32).

In the second embodiment, the S5 tunnel endpoint identifier 1102 depicted in FIG. 11 may be omitted in the HO request transmitted at step S2609.

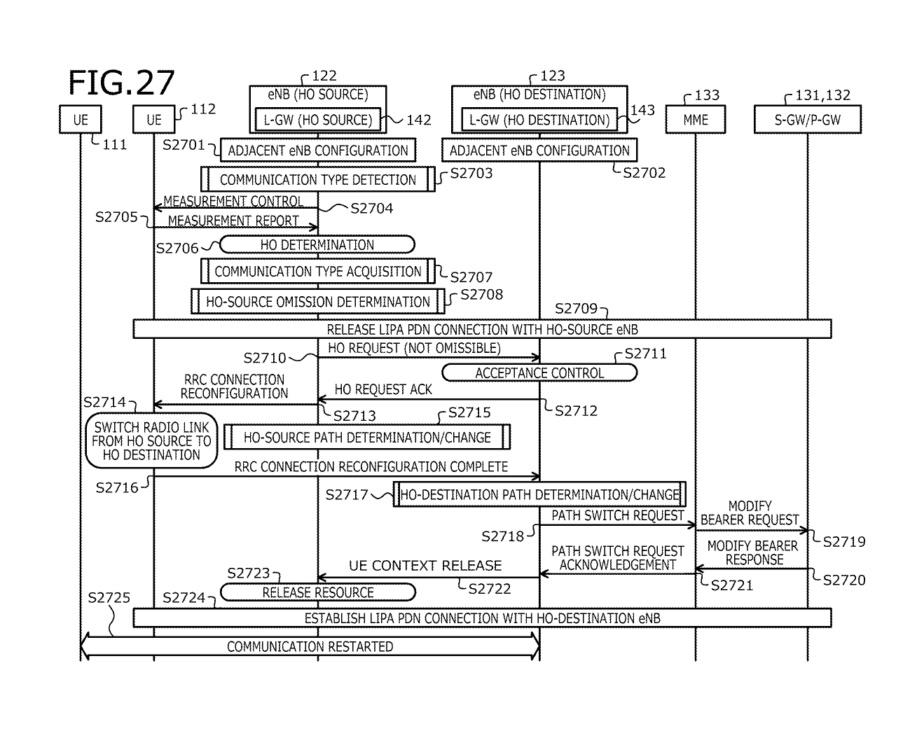

FIG. 27 is a sequence diagram of an example of a process in a case of transmitting an HO request without omitting the path change process on the NW side in the second embodiment. In the example depicted in FIG. 27, the process is described for a case where the HO request is transmitted and the path change process on the NW side is not omitted, when the HO of the terminal 112 is performed from the base station 122 to the base station 123.

Steps S2701 to S2725 depicted in FIG. 27 are similar to steps S901 to S928 depicted in FIG. 9. However, in the second embodiment, since functions of the L-GW 142 are provided in the base station 122, the processes by the L-GW 142 depicted in FIG. 9 are executed by the base station 122. The communication between the base station 122 and the L-GW 142 depicted in FIG. 9 is not performed. In the second embodiment, since functions of the L-GW 143 are provided in the base station 123, the processes by the L-GW 143 depicted in FIG. 9 are executed by the base station 123. The communication between the base station 123 and the L-GW 143 depicted in FIG. 9 is not performed.

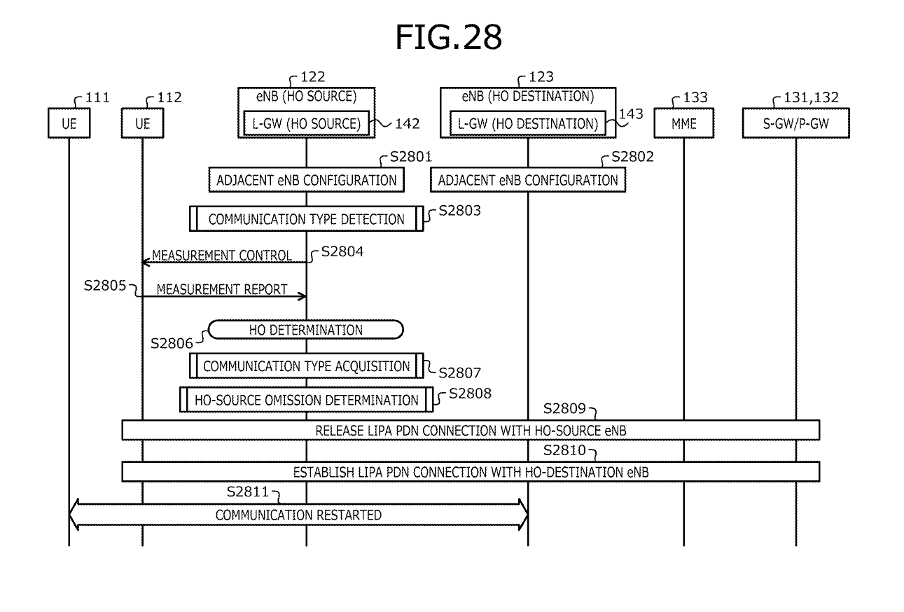

FIG. 28 is a sequence diagram of an example of a process in a case when the HO request is not transmitted in the second embodiment. In the example depicted in FIG. 28, the process is described for a case where the communicating bearers of the terminal 112 do not include communication via the P-GW 132, and the HO request is not transmitted, when the HO of the terminal 112 is performed from the base station 122 to the base station 123.

Steps S2801 to S2811 depicted in FIG. 28 are similar to steps S1001 to S1013 depicted in FIG. 10. However, in the second embodiment, since functions of the L-GW 142 are provided in the base station 122, the processes by the L-GW 142 depicted in FIG. 10 are executed by the base station 122. The communication between the base station 122 and the L-GW 142 depicted in FIG. 10 is not performed. In the second embodiment, since functions of the L-GW 143 are provided in the base station 123, the processes by the L-GW 143 depicted in FIG. 10 are executed by the base station 123. The communication between the base station 123 and the L-GW 143 depicted in FIG. 10 is not performed.

Table 10 is a table depicting an example of information stored in the inter-eNB communication path storage unit in the HO-source base station according to the second embodiment. For example, as a result of the adjacent eNB configuration at step S2601 depicted in FIG. 26, information related to communication paths between eNBs described in Table 10 is stored in the inter-eNB communication path storage unit 2521 of the HO-source base station 122. In the information related to communication paths between eNBs described in Table 10, for each base station connected to the base station 122, the cell ID of the base station is correlated with the output port of the base station 122 connected to the base station.

TABLE 10

| Cell ID | Output Port |
|---|---|
| 1 | (3) |
| 3 | (4) |

For example, since the base station 121 is connected to the base station 122 (see, e.g., FIGS. 23 and 24), in the information related to communication paths between eNBs described in Table 10, the cell ID=1 of the base station 121 is correlated with the output port=(3) of the base station 122 connected to the port 121. Since the base station 123 is connected with the base station 122, in the information related to communication paths between eNBs described in Table 10, the cell ID=3 of the base station 123 is correlated with output port=(4) of the base station 122 connected to the base station 123.

Table 11 is a table depicting an example of information stored in the inter-eNB communication path storage unit in the HO-destination base station according to the second embodiment. For example, as a result of the adjacent eNB configuration at step S2602 depicted in FIG. 26, for example, information related to communication paths between eNBs described in Table 11 is stored in the inter-eNB communication path storage unit 2521 of the HO-destination base station 123. In the information related to communication paths between eNBs described in Table 11, for each base station connected to the base station 123, the cell ID of the base station is correlated with the output port of the base station 123 connected to the base station.

TABLE 11

| Cell ID | Output Port |
|---|---|
| 2 | (7) |

For example, since the base station 122 is connected to the base station 123, in the information related to communication paths between eNBs described in Table 11, the cell ID=2 of the base station 122 corresponding to the base station 122 is correlated with the output port=(7) of the base station 123 connected with the base station 122.

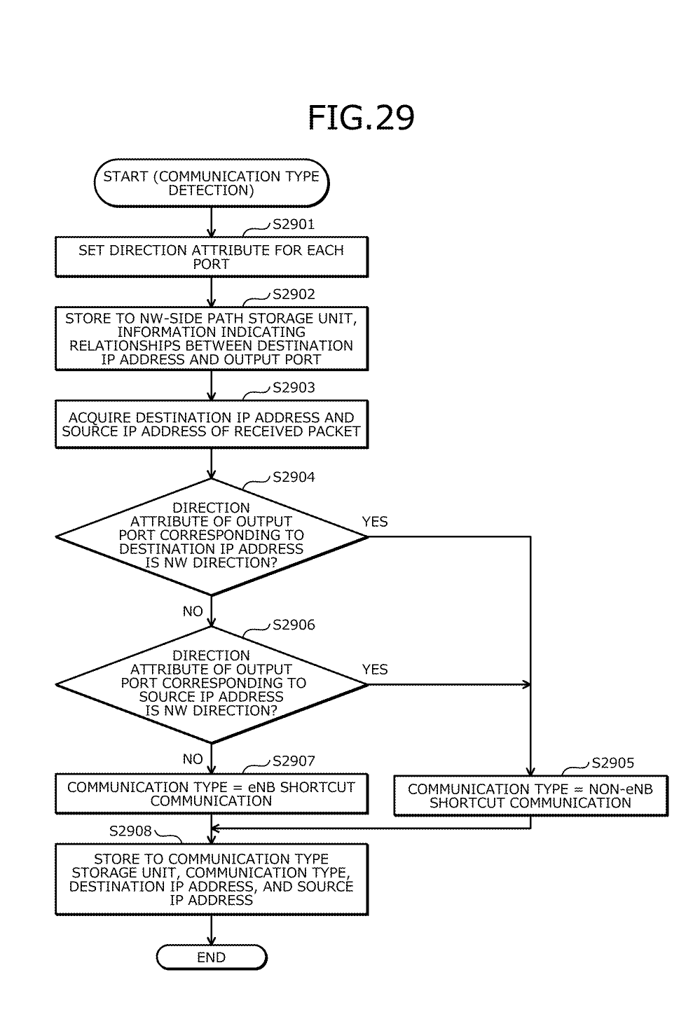

FIG. 29 is a flowchart of an example of the communication type detection process according to the second embodiment. For example, at step S2603 depicted in FIG. 26, the base station 122 executes steps depicted in FIG. 29 as the communication type detection process.

Steps S2901 to S2908 depicted in FIG. 29 are similar to steps S1201 to S1208 by the L-GW 142 depicted in FIG. 12. However, at step S2905, the base station 122 sets non-eNB shortcut communication instead of the non-L-GW shortcut communication as the communication type of the terminal 112 (step S2905). At step S2907, the base station 122 sets eNB shortcut communication instead of the L-GW shortcut communication as the communication type of the base terminal 112 (step S2907).

As described above, since the L-GWs and the eNBs are provided as physically integrated apparatuses in the second embodiment, the shortcut communication is the eNB shortcut communication shortcut at the base stations (eNBs). Therefore, the base station 122 sets the eNB shortcut communication or the non-eNB shortcut communication as the communication type of the terminal 112.

Table 12 is a table depicting an example of information stored in the port direction attribute storage unit in the HO-source base station according to the second embodiment. For example, at step S2901 depicted in FIG. 29, for example, port direction attribute information described in Table 12 is stored in the port direction attribute storage unit 514 of the HO-source base station 122. In the port direction attribute information described in Table 12, direction attributes are correlated with the respective output ports of the base station 122.

TABLE 12

| Output Port | Direction Attribute |
|---|---|
| (1) | UE Direction |
| (2) | NW Direction |
| (3) | eNB Direction |
| (4) | eNB Direction |

For example, as depicted in FIGS. 23 and 24, since the output port=(1) of the base station 122 corresponds to the terminal side, the direction attribute of the output port=(1) is the UE direction. Since the output port=(2) of the base station 122 is connected to the local network 102, the direction attribute of the output port=(2) is the NW direction. Since the output port=(3) of the base station 122 is connected to the base station 121, the direction attribute of the output port=(3) is the eNB direction. Since the output port=(4) of the base station 122 is connected to the base station 123, the direction attribute of the output port=(4) is the eNB direction.

The NW-side path information stored in the NW-side path storage unit 512 of the HO-source base station 122 at step S2902 depicted in FIG. 29 is similar to the NW-side path information described in Table 8, for example.

Table 13 is a table depicting an example of information stored in the communication type storage unit of the HO-source base station according to the second embodiment. For example, at step S2908 depicted in FIG. 29, communication type information described in Table 13 is stored in the communication type storage unit 515 of the HO-source base station 122. In the communication type information described in Table 13, the source IP address, the destination IP address, and the communication type are correlated with each other.

TABLE 13

| Source IP Address | Destination IP Address | Communication Type |
|---|---|---|
| A | B | eNB Shortcut |
| | | Communication |

The communication type information described in Table 13 is similar to the communication type information described in Table 9, for example. However, since the L-GWs and the eNBs are provided as physically integrated apparatuses in the second embodiment, the communication type in the communication type information described in Table 13 is the eNB shortcut communication or the non-eNB shortcut communication.

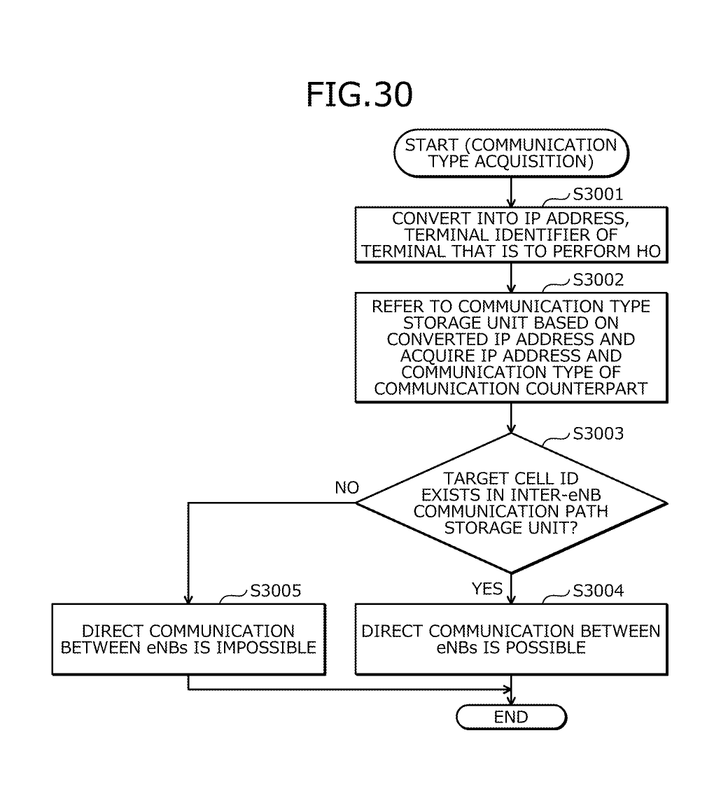

FIG. 30 is a flowchart of an example of the communication type acquisition process by the HO-source base station according to the second embodiment. For example, at step S2607 depicted in FIG. 26, the HO-source base station 122 executes steps depicted in FIG. 30 as the communication type acquisition process. Steps S3001 to S3005 depicted in FIG. 30 are similar to steps S1301 to S1305 by the L-GW 142 depicted in FIG. 13.

However, at step S3003, the base station 122 determines whether the target cell ID of the HO-destination base station 123 of the terminal 112 exists in the inter-eNB communication path storage unit 2521 (step S3003). At step S3004, the base station 122 determines that direct communication between eNBs is possible for the terminal 112 (step S3004). At step S3005, the base station 122 determines that direct communication between eNBs is impossible for the terminal 112 (step S3005).

For example, the HO-source omission determination process and the process based on the HO-source omission determination process executed by the HO-source base station 122 at steps S2608, S2609 depicted in FIG. 26 are similar to the processes depicted in FIG. 14.

FIG. 31 is a flowchart of an example of the HO-source path determination process and the HO-source path change process according to the second embodiment. At step S2614 depicted in FIG. 26, for example, the HO-source base station 122 executes steps depicted in FIG. 31 as the HO-source path determination process and the HO-source path change process (HO-source path determination/change process).

The steps depicted in FIG. 31 integrate the HO-source path determination process by the base station 122 depicted in FIG. 15 and the HO-source path change process by the L-GW 142 depicted in FIG. 16. Therefore, first, the base station 122 determines whether the omission possibility information is set to omissible in the omission possibility storage unit 721 by the HO-source omission determination process depicted in FIG. 14 (step S3101).

If the omission possibility information is set to omissible at step S3101 (step S3101: YES), the base station 122 refers to the inter-eNB communication path storage unit 2521 to convert the target cell ID of the HO destination included in the HO-source path change request from the base station 122, into the port number (step S3102).

In the NW-side path storage unit 512, the base station 122 then changes the output port corresponding to the IP address of the terminal 112 that is to perform HO, to the port number after the conversion of step S3102 (step S3103) and terminates the series of processes.

At step S3101, in a case where the omission possibility information is not set to omissible (step S3101: NO), the base station 122 terminates the series of processes without executing the HO-source path change process. This case corresponds to the process depicted in FIG. 27, for example.

FIG. 32 is a flowchart of an example of the HO-destination path determination process and the HO-destination path change process according to the second embodiment. At step S2616 depicted in FIG. 26, for example, the HO-destination base station 123 executes steps depicted in FIG. 32 as the HO-destination path determination process and the HO-destination path change process.

The steps depicted in FIG. 32 integrate the HO-destination path determination process by the base station 123 depicted in FIG. 17 and the HO-destination path change process by the L-GW 143 depicted in FIG. 18. Therefore, first, the base station 123 determines whether the omission possibility information included in the HO request received from the base station 122 is set to omissible (step S3201).

At step S3201, in a case where the omission possibility information is set to omissible (step S3201: YES), the base station 123 sets the output port corresponding to the IP address=B of the terminal 112 that is to perform HO to the UE direction (step S3202). The base station 123 then refers to the inter-eNB communication path storage unit 2521 to convert the source cell ID that is the ID of the base station 123 into the port number (step S3203).

In the NW-side path storage unit 512, the base station 123 then changes the output port corresponding to the IP address of the terminal 111 communicating with the terminal 112 that is to perform HO, to the port number after conversion of step S3203 (step S3204).

The base station 123 then transmits a UE context release to the HO-source base station 122 (HO-source eNB) (step S3205) and terminates the series of processes. This case corresponds to the process depicted in FIG. 26, for example.

At step S3201, in a case where the omission possibility information is not set to omissible (step S3201: NO), the base station 123 transmits a path switch request to the MME 133 (step S3206) and terminates the series of processes. This case corresponds to the process depicted in FIG. 27, for example.

In this way, according to the wireless communications system 100 according to the second embodiment, even in the configuration in which an L-GW and an eNB are provided as a physically integrated apparatus, the instantaneous interruption time at HO can be reduced as in the wireless communications system 100 according to the first embodiment.

A third embodiment will be described in terms of parts different from the first embodiment. Although L-GWs are provided for respective base stations in the configuration described in the first embodiment, multiple base stations share a same L-GW in the configuration described in the third embodiment.

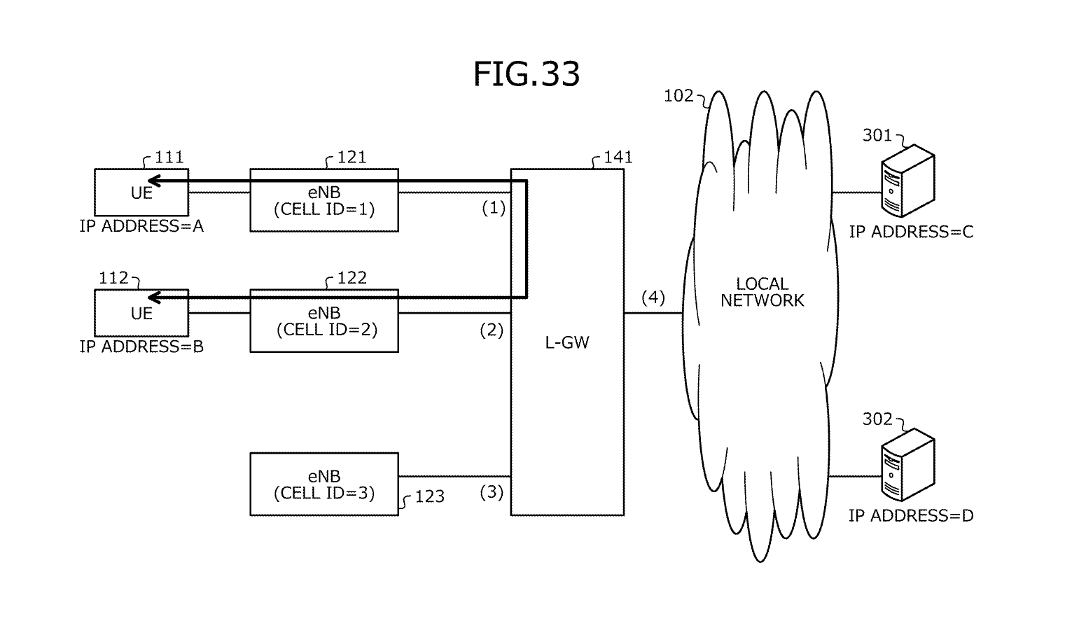

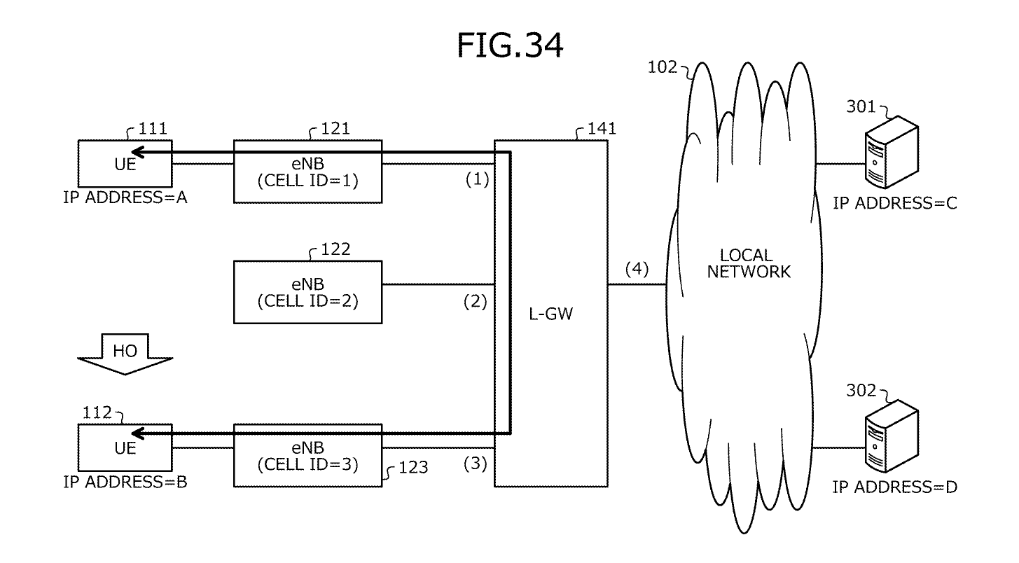

FIGS. 33 and 34 are diagrams of examples of the configuration of L-GWs and HO according to the third embodiment. In FIGS. 33 and 34, parts similar to those depicted in FIGS. 3 and 4 are denoted by the same reference numerals used in FIGS. 3 and 4, and will not be described. In the examples depicted in FIGS. 33 and 34, the base stations 121 to 123 are connected with the one L-GW 141.

First, as depicted in FIG. 33, it is assumed that the terminals 111, 112 are connected to the base stations 121, 122, respectively, and that communication is performed between the terminals 111, 112 through a data path passing through the base station 121, the L-GW 141, and the base station 122. Subsequently, as depicted in FIG. 34, it is assumed that HO of the terminal 112 has occurred from the base station 122 to the base station 123 due to movement, etc. of the terminal 112. As a result, communication is performed between the terminals 111, 112 through a data path passing through the base station 121, the L-GW 141, and the base station 123.

In FIGS. 33 and 34, (1) to (4) denote numbers of output ports in the L-GW 141 shared by the base stations 121 to 123. For example, (1) denotes the number of the output port (UE direction) connected to the base station 121, in the L-GW 141; (2) denotes the number of the output port (UE direction) connected to the base station 122, in the L-GW 141; (3) denotes the number of the output port (UE direction) connected to the base station 123, in the L-GW 141; and (4) denotes the number of the output port (NW direction) connected to the local network 102, in the L-GW 141.

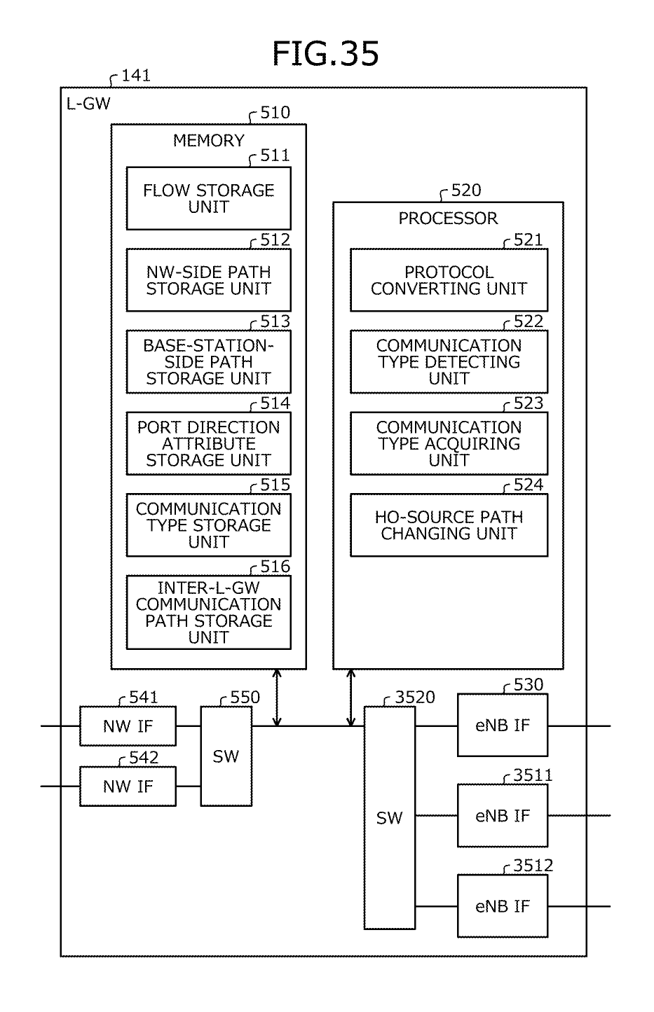

FIG. 35 is a diagram of an example of the L-GW according to the third embodiment. In FIG. 35, parts similar to those depicted in FIG. 5 are denoted by the same reference numerals used in FIG. 5, and will not be described. As depicted in FIG. 35, the L-GW 141 according to the third embodiment includes base station interfaces 3511, 3512 and a switch 3520 in addition to the configuration depicted in FIG. 5.

The base station interface 530 is a communication interface for the base station 121. The base station interfaces 3511, 3512 (eNB IFs) are communication interfaces for the base stations 122, 123, respectively. The base station interfaces 530, 3511, 3512 are switched by the switch 3520 (SW) and used.

Since the L-GW 141 according to the third embodiment corresponds to both the HO-source base station 122 and the HO-destination base station 123, the HO destination path changing unit 525 depicted in FIG. 5 can be omitted.

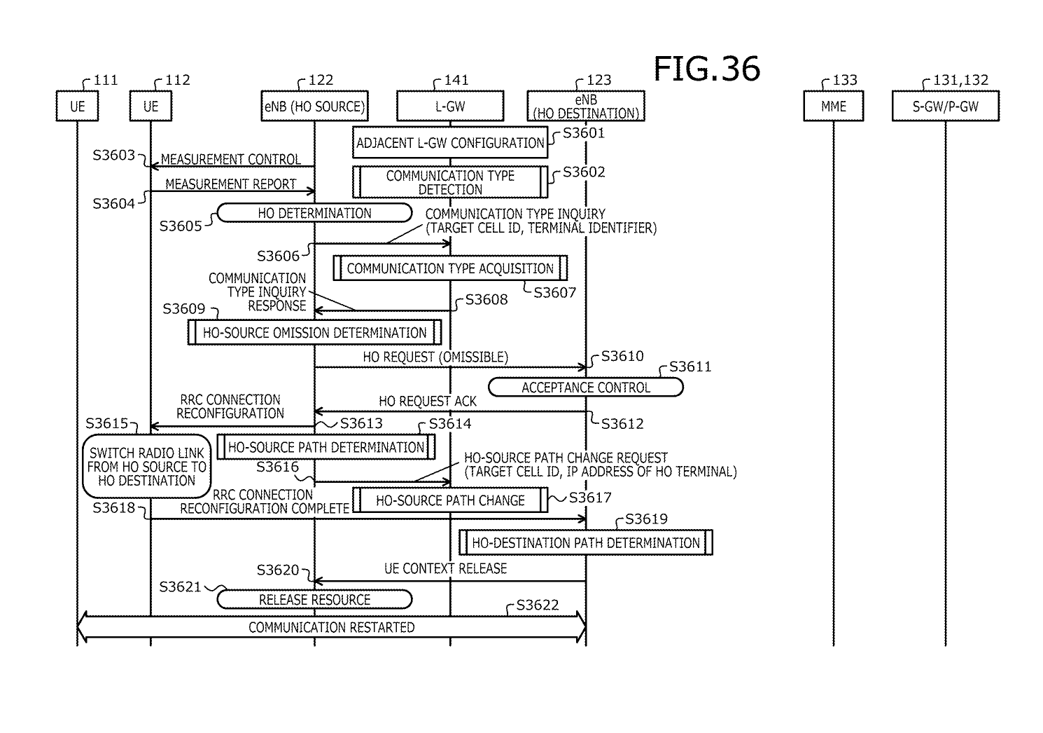

FIG. 36 is a sequence diagram of an example of a process in the case of transmitting an HO request and omitting a path change process in the third embodiment. In the wireless communications system 100 according to the third embodiment, for example, steps depicted in FIG. 36 are executed. In the example depicted in FIG. 36, description is given for a case where the HO request is transmitted and the path change process is omitted, when the HO of the terminal 112 is performed from the base station 122 to the base station 123.

Steps S3601 to S3622 depicted in FIG. 36 are similar to steps S801 to S825 depicted in FIG. 8. However, since the third embodiment has a configuration in which the base stations 121 to 123 share the L-GW 141, the processes by the L-GW 142 depicted in FIG. 8 are executed by the L-GW 141.

The processes by the L-GW 143 depicted in FIG. 8 are unnecessary. For example, a direct communication path via the L-GW can be established by the HO-source path change process by the L-GW 141 at step S3617. Therefore, the base station 123 does not need to transmit the HO-destination path change request or execute the HO-destination path change process.

In the third embodiment, the IP addresses 1103, 1104 and the source cell ID 1105 depicted in FIG. 11 may be omitted in the HO request transmitted at step S3610.

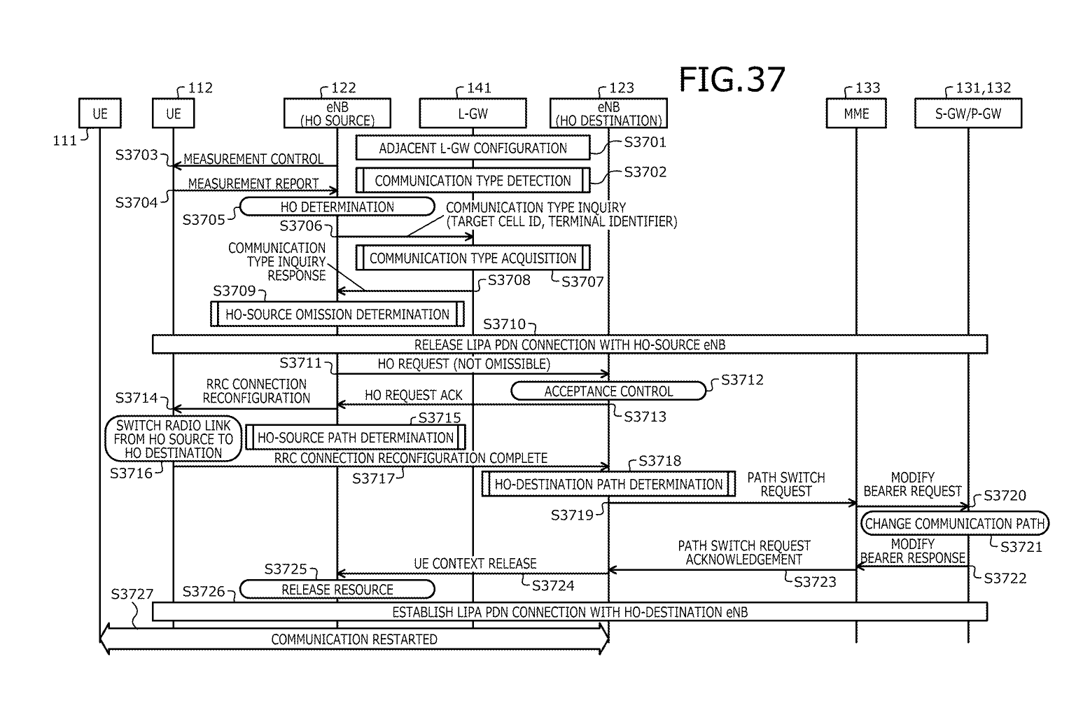

FIG. 37 is a sequence diagram of an example of a process in a case of transmitting an HO request without omitting the path change process on the NW side in the third embodiment. In the example depicted in FIG. 37, the process is described for a case where the HO request is transmitted and the path change process on the NW side is not omitted, when the HO of the terminal 112 is performed from the base station 122 to the base station 123.

Steps S3701 to S3727 depicted in FIG. 37 are similar to steps S901 to S928 depicted in FIG. 9. However, since the third embodiment has a configuration in which the base stations 121 to 123 share the L-GW 141, the processes by the L-GW 142 depicted in FIG. 9 are executed by the L-GW 141.

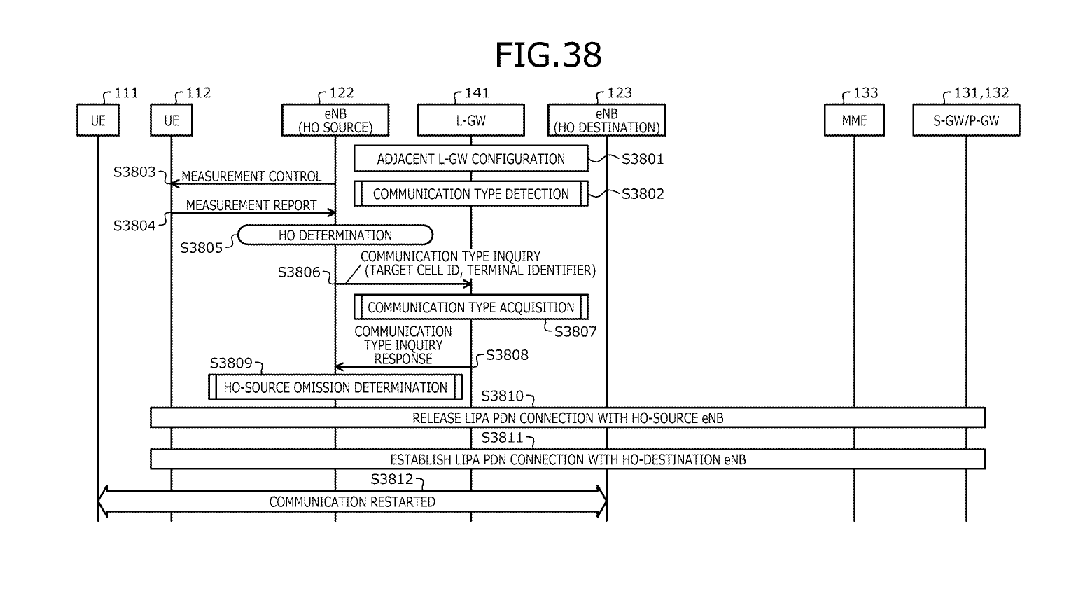

FIG. 38 is a sequence diagram of an example of a process in a case when the HO request is not transmitted in the third embodiment. In the example depicted in FIG. 38, when the HO of the terminal 112 is performed from the base station 122 to the base station 123, the communicating bearers of the terminal 112 do not include communication via the P-GW 132, and the HO request is not transmitted.

Steps S3801 to S3812 depicted in FIG. 38 are similar to steps S1001 to S1013 depicted in FIG. 10. However, since the third embodiment has a configuration in which the base stations 121 to 123 share the L-GW 141, the processes by the L-GW 142 depicted in FIG. 10 are executed by the L-GW 141.

Table 14 is a table depicting an example of information stored in the inter-L-GW communication path storage unit in the L-GW according to the third embodiment. For example, as a result of the adjacent L-GW configuration at step S3601 depicted in FIG. 36, for example, information related to communication paths between L-GWs described in Table 14 is stored in the inter-L-GW communication path storage unit 516 of the L-GW 141. In the information related to communication paths between L-GWs described in Table 14, for each base station connected to the L-GW 141, the cell ID of the base station is correlated with the output port of the L-GW 141 connected to the base station.

TABLE 14

| Cell ID | Output Port |
|---|---|
| 1 | (1) |
| 2 | (2) |
| 3 | (3) |

For example, as depicted in FIGS. 33 and 34, the base station 121 is connected with the L-GW 141. Therefore, in the information related to communication paths between L-GWs described in Table 14, the cell ID=1 of the base station 121 is correlated with the output port=(1) of the L-GW 141 connected with the base station 121.

Since the base station 122 is connected to the L-GW 141, in the information related to communication paths between L-GWs described in Table 14, the cell ID=2 of the base station 122 is correlated with the output port=(2) of the L-GW 141 connected to the base station 122. Since the base station 123 is connected to the L-GW 141, in the information related to communication paths between L-GWs described in Table 14, the cell ID=3 of the base station 123 is correlated with the output port=(3) of the L-GW 141 connected to the base station 123.

The communication type detection process executed by the L-GW 141 at step S3602 depicted in FIG. 36, for example, is similar to the process by the L-GW 142 depicted in FIG. 12, for example.

Table 15 is a table depicting an example of information stored in the port direction attribute storage unit in the L-GW according to the third embodiment. In the third embodiment, at step S1201 depicted in FIG. 12, for example, port direction attribute information described in Table 15 is stored in the port direction attribute storage unit 514 of the L-GW 141. In the port direction attribute information described in Table 15, direction attributes are correlated with the respective output ports of the L-GW 141.

TABLE 15

| Output Port | Direction Attribute |
|---|---|
| (1) | UE Direction |
| (2) | UE Direction |
| (3) | UE Direction |
| (4) | NW Direction |

For example, as depicted in FIGS. 33 and 34, since the output port=(1) of the L-GW 141 is connected to the base station 121, the direction attribute of the output port=(1) is the UE direction. Since the output port=(2) of the L-GW 141 is connected to the base station 122, the direction attribute of the output port=(2) is the UE direction.

Since the output port=(3) of the L-GW 141 is connected to the base station 123, the direction attribute of the output port=(3) is the UE direction. Since the output port=(4) of the L-GW 141 is connected to the local network 102, the direction attribute of the output port=(4) is the NW direction.

Table 16 is a table depicting an example of information stored in the NW-side path storage unit of the L-GW according to the third embodiment. In the third embodiment, at step S1202 depicted in FIG. 12, for example, NW-side path information described in Table 16 is stored in the NW-side path storage unit 512 of the L-GW 141. In the NW-side path information described in Table 16, the output ports of the L-GW 141 are correlated with respective destination IP addresses.

TABLE 16

| Destination IP Address | Output Port |
|---|---|
| A | (1) |
| B | (2) |
| C | (4) |
| D | |

For example, as depicted in FIGS. 33 and 34, since the destination IP address=A is the address of the terminal 111, the output port=(1) corresponding to the direction of the terminal 111 (the base station 121) is correlated with the destination IP address=A. Since the destination IP address=B is the address of the terminal 112, the output port=(2) corresponding to the direction of the terminal 112 (the base station 122) is correlated with the destination IP address=B before the HO of the base station 122. Due to the HO of the terminal 112 to the base station 123, the output port correlated with the destination IP address=B is changed to the output port=(3) corresponding to the direction of the terminal 112 (the base station 123).

Since the destination IP address=C is the address of the server 301, the output port=(4) corresponding to the direction of the server 301 (the local network 102) is correlated with the destination IP address C. Since the destination IP address=D is the address of the server 302, the output port=(4) corresponding to the direction of the server 302 (the local network 102) is correlated with the destination IP address=D.

In the third embodiment, the communication type information stored in the communication type storage unit 515 of the L-GW 141 at step S1208 depicted in FIG. 12 is similar to the communication type information described in Table 9, for example.

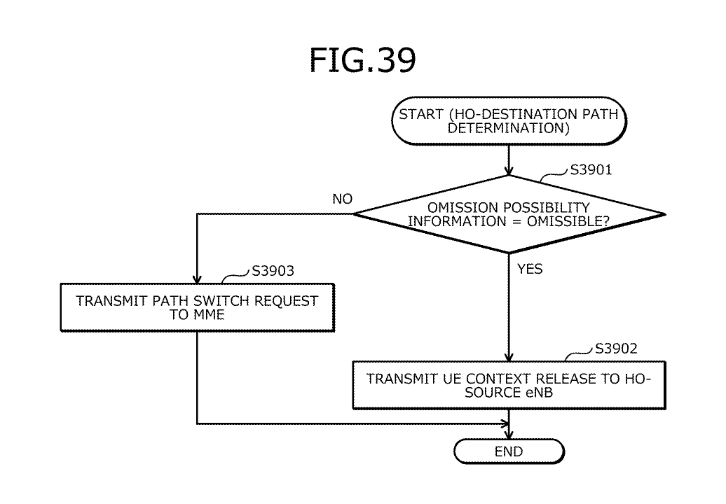

FIG. 39 is a flowchart of an example of the HO-destination path determination process and a process based on the HO destination path determination process according to the third embodiment. For example, at step S3619 depicted in FIG. 36, the HO-destination base station 123 executes steps depicted in FIG. 39 as the HO-destination path determination process.

The steps depicted in FIG. 39 are similar to the steps depicted in FIG. 17. However, the third embodiment has as a configuration in which the base stations 121 to 123 share the L-GW 141, and the path establishment is completed by the HO-source path change process at step S3617 depicted in FIG. 36. Therefore, as depicted in FIG. 39, the process of transmitting the HO-destination path establishment request to the HO-destination L-GW 143 such as that at step S1702 depicted in FIG. 17 can be omitted.

In this way, according to the wireless communications system 100 of the third embodiment, even in the configuration in which multiple base stations share the same L-GW, the instantaneous interruption time at HO can be reduced as in the wireless communications system 100 according to the first embodiment.

As described above, according to the wireless communications system, the wireless communications apparatus, and the handover control method, the instantaneous interruption time at handover can be reduced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wireless communications system comprising:
a first relay apparatus connected to a first communications network;
a second relay apparatus different from the first relay apparatus and connected to a second communications network different from the first communications network;
a second terminal configured to communicate with a first terminal via the second relay apparatus; and
a wireless communications apparatus that, when performing handover of the second terminal, disconnects communication via the second relay apparatus and performs the handover by a path change of the first relay apparatus when the communication via the second relay apparatus passes through the second communications network, the wireless communications apparatus performing the handover through a path change of the second relay apparatus without disconnecting the communication via the second relay apparatus when the communication via the second relay apparatus does not pass through the second communications network.

2. The wireless communications system according to claim 1, wherein
the wireless communications apparatus disconnects the communication via the second relay apparatus and performs the handover through a path change of the first relay apparatus, when the communication via the second relay apparatus passes through the second communications network and communication of the second terminal via the first relay apparatus exists, and
the wireless communications apparatus disconnects the communication via the second relay apparatus and does not perform the handover through a path change of the first relay apparatus, when the communication via the second relay apparatus passes through the second communications network and communication of the second terminal via the first relay apparatus does not exist.

3. The wireless communications system according to claim 1, wherein
the wireless communications apparatus transmits to a handover-destination base station of the second terminal, information corresponding to whether the communication via the second relay apparatus passes through the second communications network, and
the handover-destination base station of the second terminal makes a path change of the first relay apparatus when the communication via the second relay apparatus passes through the second communications network, and makes a path change of the second relay apparatus when the communication via the second relay apparatus does not pass through the second communications network, based on the information transmitted by the wireless communications apparatus.

4. The wireless communications system according to claim 1, wherein
the second relay apparatus determines whether the communication via the second relay apparatus passes through the second communications network, based on whether among the communication ports of the second relay apparatus, a communication port corresponding to at least one of a destination and a source of data in the communication via the second relay apparatus is connected to the second communications network, and wherein
the wireless communications apparatus based on a result of the determination, disconnects the communication via the second relay apparatus and performs the handover through a path change of the first relay apparatus when the communication via the second relay apparatus passes through the second communications network, and performs the handover through a path change of the second relay apparatus without disconnecting the communication via the second relay apparatus when the communication via the second relay apparatus does not pass through the second communications network.

5. A wireless communications apparatus in a wireless communications system including a first relay apparatus connected to a first communications network and a second relay apparatus different from the first relay apparatus and connected to a second communications network different from the first communications network, the wireless communications apparatus comprising:
an interface configured to acquire information that indicates whether communication via the second relay apparatus passes through the second communications network, the interface acquiring the information when handover of a second terminal communicating with a first terminal via the second relay apparatus is performed;
a memory; and
a processor coupled to the memory, the processor configured to disconnect the communication via the second relay apparatus and perform the handover through a path change of the first relay apparatus when the communication via the second relay apparatus passes through the second communications network, and to perform the handover through a path change of the second relay apparatus without disconnecting the communication via the second relay apparatus when the communication via the second relay apparatus does not pass through the second communications network, based on the information acquired by the interface.

6. A handover method in a wireless communications system including a first relay apparatus connected to a first communications network and a second relay apparatus different from the first relay apparatus and connected to a second communications network different from the first communications network, the handover method comprising:
acquiring, by an interface, information that indicates whether communication via the second relay apparatus passes through the second communications network, the interface acquiring the information when handover of a second terminal communicating with a first terminal via the second relay apparatus is performed; disconnecting the communication via the second relay apparatus and performing the handover by a processor, the processor disconnecting the communication via the second relay apparatus and performing the handover through a path change of the first relay apparatus when the communication via the second relay apparatus passes through the second communications network, based on the information acquired by the interface; and
performing the handover by the processor, the processor performing the handover through a path change of the second relay apparatus without disconnecting the communication via the second relay apparatus when the communication via the second relay apparatus does not pass through the second communications network, based on the information acquired by the interface.
